(19) United States
(12) Patent Application Publication
(10) Pub. No.: US 2025/0332594 A1
(43) Pub. Date: Oct. 30, 2025

(54) METHOD FOR REAGENT-SPECIFIC DRIVING EWOD ARRAYS IN MICROFLUIDIC SYSTEMS

(71) Applicant: NUCLERA LTD, Cambridge (GB)

(72) Inventors: Maheshwar Adiraj Iyer, Billerica, MA (US); Rohina Khanna, Billerica, MA (US); Richard J. Paolini, Billerica, MA (US); Luke M. Slominski, Billerica, MA (US); David Zhitomirsky, Billerica, MA (US)

(21) Appl. No.: 18/855,580

(22) PCT Filed: Apr. 13, 2023
(86) PCT No.: PCT/US2023/018568

§ 371 Date: Oct. 9, 2024

Related U.S. Application Data
(60) Provisional application No. 63/330,697, filed on Apr. 13, 2022.

(51) Int. Cl. B01L 3/00

(52) U.S. Cl. CPC B01L 3/502792; B01L 2200/0673; B01L 2200/16; B01L 2300/0645; B01L 2400/0427

(57) ABSTRACT

An electrowetting system for actuating droplets of a first composition and of a second composition. The system includes: a plurality of electrodes configured to manipulate droplets of fluid in a microfluidic space, each electrode being coupled to circuitry which applies driving voltages to the electrode; and a processing unit operably connected to a look up table correlating drive sequences to chemical species and at least one composition parameter. The pulse sequence of driving voltages to move at least one of the droplets contains at least three consecutive positive pulses or is positively biased.

### RELATED APPLICATIONS

This application claims the benefit of and priority to U.S. Provisional Application Ser. No. 63/330,697 filed on Apr. 13, 2022, which is incorporated herein by reference in its entirety.

### BACKGROUND

Digital microfluidic (DMF) devices use independent electrodes to propel, split, and join droplets in a confined environment, thereby providing a “lab-on-a-chip.” Digital microfluidic devices have been used to actuate a wide range of volumes (nanoliter nL to microliter μL) and are alternatively referred to as electrowetting on dielectric, or “EWoD,” to further differentiate the method from competing microfluidic systems that rely on electrophoretic flow and/or micropumps. In electrowetting, a continuous or pulsed electrical signal is applied to a droplet, leading to switching of its contact angle. Liquids capable of electrowetting a hydrophobic surface often include a polar solvent, such as water or an ionic liquid, and often feature ionic species, as is the case for aqueous solutions of electrolytes. A 2012 review of the electrowetting technology was provided by Wheeler in “Digital Microfluidics,” Annu. Rev. Anal. Chem. 2012, 5:413-40. The technique allows sample preparation, assays, and synthetic chemistry to be performed with tiny quantities of both samples and reagents. In recent years, controlled droplet manipulation in microfluidic cells using electrowetting has become commercially viable, and there are now products available from large life science companies.

There are two main architectures of EWoD digital microfluidic devices, i.e., open and closed systems. Often, both EWoD configurations include a bottom plate featuring a stack of propulsion electrodes, an insulator dielectric layer, and a hydrophobic layer providing a working surface. However, closed systems also feature a top plate parallel to the bottom plate and including a top electrode serving as common counter electrode to all the propulsion electrodes. The top and bottom plates are provided in a spaced relationship defining a microfluidic region to permit droplet motion within the microfluidic region under application of propulsion voltages between the bottom electrode array and the top electrode. A droplet is placed on the working surface, and the electrodes, once actuated, can cause the droplet to deform and wet or de-wet from the surface depending on the applied voltage. When the electrode matrix of the device is being driven, each pixel of the DMF receives a voltage pulse (i.e., a voltage differential between the two electrodes associated with that pixel) or temporal series of voltage pulses (i.e., a “waveform” or “drive sequence” or “driving sequence”) in order to effect a transition from one electrowetting state of the pixel to another.

Most of the literature reports on EWoD involve so-called “segmented” devices, whereby ten to several hundred electrodes are directly driven with a controller. While segmented devices are easy to fabricate, the number of electrodes is limited by space and driving constraints and the devices need to be designed for specific applications. Accordingly, it may prove relatively problematic to perform massive parallel assays, reactions, etc. in segmented devices. In comparison, “active matrix” devices (a.k.a. active matrix EWoD, a.k.a. AM-EWoD) devices can have many thousands, hundreds of thousands or even millions of addressable electrodes and provide a general purpose panel that can be used for many different applications.

The electrodes of an AM-EWoD are often switched by a transistor matrix, such as thin-film transistors (TFTs), although electro-mechanical switches may also be used. TFT-based thin film electronics may be used to control the addressing of voltage pulses to an EWoD array by using circuit arrangements very similar to those employed in AM display technologies. TFT arrays are highly desirable for this application, due to having thousands of addressable pixels, thereby allowing mass parallelization of droplet procedures. Driver circuits can be integrated onto the AM-EWoD array substrate, and TFT-based electronics are well suited to the AM-EWoD application.

### SUMMARY OF INVENTION

In one embodiment, there is provided an electrowetting system for actuating different droplet compositions using different pulse sequences. A balance must be found between pulse sequences which are effective to move droplets, but which to not harm the array of electrodes. A pulse sequence may be a charged balanced sequence alternating 1, −1. Such a sequence minimises harm the array, but may not be sufficient to move all droplet compositions. Droplets which are for example more visco-elastic, have a high ionic strength or a high concentration of polymeric reagents may be harder to move or split. Therefore a pulse sequence having a string of pulses, for example three or four consecutive pulses of the same charge may be used. However such charge build-up harms the array, and is not ideal unless necessary. Thus the use of repetitive pulses may be used where needed by certain droplet reagents, but is not needed for each droplet on the array.

In another embodiment, there is provided an electrowetting system for actuating aqueous droplets using a sequence of electrical pulses, the system including a plurality of electrodes configured to manipulate aqueous droplets in a microfluidic space, wherein each electrode is coupled to circuitry configured to selectively apply a sequence of driving voltages to the electrodes. In some embodiments, the pulse sequence of driving voltages to move the droplet contains at least three consecutive positive pulses. In some embodiments, the pulse sequence can prevent fouling (e.g., reduce fouling and/or avoid fouling). The pulse sequence can include at least one of 1,0,−1; 1,0,0,−1; 1,0,0,0,−1; 1,0,−1,−1; 1,−1,0,−1; 1,1,0,0,0,−1,−1; or 1,−1,0,1,−1. The pulse sequence having 1,0,−1,−1 can both prevent fouling and move the droplets. The pulse sequence having 1,0,0,0,−1 can both prevent fouling and hold the droplets for extended periods.

In another embodiment, there is provided an electrowetting system for actuating aqueous droplets using a sequence of electrical pulses, the system including a plurality of electrodes configured to manipulate aqueous droplets in a microfluidic space, wherein each electrode is coupled to circuitry configured to selectively apply a sequence of driving voltages to the electrodes. In some embodiments, the pulse sequence of driving voltages to move the droplet contains is positively biased such that the electrodes have a positive charge for longer than a negative charge. Such positively biased pulse sequences may harm the array, and their use is minimized and only when necessary for moving particular reagents.=

In another embodiment, there is provided an electrowetting system for actuating droplets of a first composition and droplets of a second composition, wherein the first droplet is moved using a pulse sequence of driving voltages which contains at least three consecutive positive pulses.

In another embodiment, there is provided an electrowetting system for actuating droplets of a first composition and droplets of a second composition, wherein the first droplet is moved using a pulse sequence of driving voltages which is positively biased. The positive bias can be introduced either via a longer positive actuation or via multiple positive pulses.

In another embodiment, there is provided an electrowetting system for actuating droplets of a first composition and droplets of a second composition. In some embodiments, the pulse sequence for actuating the droplets of the first composition can prevent fouling (e.g., reduce fouling and/or avoid fouling). The pulse sequence can include at least one of 1,0,−1; 1,0,0,−1; 1,0,0,0,−1; 1,0,−1,−1; 1,−1,0,−1; 1,1,0,0,0,−1,−1; or 1,−1,0,1,−1. The pulse sequence having 1,0,−1,−1 can both prevent fouling and move the droplets. The pulse sequence having 1,0,0,0,−1 can both prevent fouling and hold the droplets for extended periods.

The system includes: a plurality of electrodes configured to manipulate droplets of fluid in a microfluidic space, wherein each electrode is coupled to circuitry configured to selectively apply driving voltages to the electrode; and a processing unit operably connected to a storage medium, which may include a look up table (LUT) correlating drive sequences to chemical species and at least one composition parameter. The processing unit is configured to: receive input data of a first chemical species and a first composition parameter of the first composition; receive input data of a second chemical species and a second composition parameter of the second composition; correlate a first drive sequence with the first chemical species and the first composition parameter; correlate a second drive sequence with the second chemical species and the second composition parameter; and output the first drive sequence and the second drive sequence to the plurality of electrodes. The first and second drive sequences may be different depending on the composition within the droplet. In some embodiments, at least one of the drive sequences contains at least three consecutive positive pulses. The drive sequences may contain at least four consecutive positive pulses. In some embodiments, the drive sequence can prevent fouling (e.g., reduce fouling and/or avoid fouling). The drive sequences includes at least one of 1,0,−1; 1,0,0,−1; 1,0,0,0,−1; 1,0,−1,−1; 1,−1,0,−1; 1,1,0,0,0,−1,−1; or 1,−1,0,1,−1. The drive sequence having 1,0,−1,−1 can both prevent fouling and move the droplets. The pulse sequence having 1,0,0,0,−1 can both prevent fouling and hold the droplets for extended periods.

In another embodiment, there is provided a method for performing droplet operations on a first composition and a second composition in an electrowetting system. In another embodiment, there is provided a method for performing droplet operations on a first composition and a second composition in an electrowetting system, the electrowetting system comprising a plurality of electrodes configured to manipulate droplets of fluid in a microfluidic space, wherein each electrode is coupled to circuitry configured to selectively apply driving voltages to the electrode; and driving the first composition with a pulse sequence of driving voltages which contains at least three consecutive positive pulses or is positively biased and driving the second composition with a charge-neutral drive sequence alternating 1, −1. In some embodiments, the drive sequence for driving the first composition can prevent fouling (e.g., reduce fouling and/or avoid fouling). The drive sequence can include at least one of 1,0,−1; 1,0,0,−1; 1,0,0,0,−1; 1,0,−1,−1; 1,−1,0,−1; 1,1,0,0,0,−1,−1; or 1,−1,0,1,−1. The drive sequence having 1,0,−1,−1 can both prevent fouling and move the droplets. The pulse sequence having 1,0,0,0,−1 can both prevent fouling and hold the droplets for extended periods.

The electrowetting system may comprise: a plurality of electrodes configured to manipulate droplets of fluid in a microfluidic space, wherein each electrode is coupled to circuitry configured to selectively apply driving voltages to the electrode; and a processing unit operably connected to a storage medium, which may include a look up table (LUT) correlating drive sequences to chemical species and composition parameters. The method comprises: receiving input data of a first chemical species and a first composition parameter of the first composition; receiving input data of a second chemical species and a second composition parameter of the second composition; correlating a first drive sequence with the first chemical species and first composition parameter of the first composition; correlating a second drive sequence with the second chemical species and second composition parameter of the second composition; and outputting the first drive sequence and the second drive sequence to the plurality of electrodes. In some embodiments, at least one of the drive sequences contains at least three consecutive positive pulses. The drive sequences may contain at least four consecutive positive pulses. In some embodiments, the drive sequence can prevent fouling (e.g., reduce fouling and/or avoid fouling). The drive sequences includes at least one of 1,0,−1; 1,0,0,−1; 1,0,0,0,−1; 1,0,−1,−1; 1,−1,0,−1; 1,1,0,0,0,−1,−1; or 1,−1,0,1,−1. The drive sequence having 1,0,−1,−1 can both prevent fouling and move the droplets. The pulse sequence having 1,0,0,0,−1 can both prevent fouling and hold the droplets for extended periods.

In another embodiment, there is provided an electrowetting system for actuating a mixed droplet, the system including: a plurality of electrodes configured to manipulate droplets of fluid in a microfluidic space, wherein each electrode is coupled to circuitry configured to selectively applying driving voltages to the electrode; and a processing unit operably connected to a storage medium, which may include a look up table (LUT) correlating drive sequences to chemical species and at least one composition parameter. The processing unit is configured to: provide a first droplet with a first composition, a first volume, and a first composition parameter, wherein at least one of the first composition, first volume, and first composition parameter is correlated with a first drive sequence for the electrowetting system; provide a second droplet with a second composition, a second volume, and a second composition parameter, wherein at least one of the second composition, second volume, and second composition parameter is correlated with a second drive sequence for the electrowetting system; mix the first droplet and the second droplet to create a mixed droplet; and drive the mixed droplet with a third drive sequence that is a predetermined weighted average of the first drive sequence and the second drive sequence. In some embodiments, at least one of the drive sequences contains at least three consecutive positive pulses. The drive sequences may contain at least four consecutive positive pulses. In some embodiments, the drive sequence for driving the first composition can prevent fouling (e.g., reduce fouling and/or avoid fouling). The drive sequence can include at least one of 1,0,−1; 1,0,0,−1; 1,0,0,0,−1; 1,0,−1,−1; 1,−1,0,−1; 1,1,0,0,0,−1,−1; or 1,−1,0,1,−1. The drive sequence having 1,0,−1,−1 can both prevent fouling and move the droplets. The pulse sequence having 1,0,0,0,−1 can both prevent fouling and hold the droplets for extended periods.

In another embodiment, there is provided an electrowetting system for actuating droplets of at least one composition, the system including: a plurality of electrodes configured to manipulate droplets of fluid in a microfluidic space, wherein each electrode is coupled to circuitry configured to selectively apply driving voltages to the electrode; and a processing unit operably connected to a storage medium, which may include a look up table (LUT) correlating drive sequences to chemical species and at least one composition parameter, the processing unit being configured or programmed to: receive input data of a chemical species and a composition parameter of the at least one composition; correlate a drive sequence with the chemical species and the composition parameter; and output the drive sequence to the plurality of electrodes. In some embodiments, at least one of the drive sequences contains at least three consecutive positive pulses. The drive sequences may contain at least four consecutive positive pulses. In some embodiments, the drive sequence for driving the first composition can prevent fouling (e.g., reduce fouling and/or avoid fouling). The drive sequence can include at least one of 1,0,−1; 1,0,0,−1; 1,0,0,0,−1; 1,0,−1,−1; 1,−1,0,−1; 1,1,0,0,0,−1,−1; or 1,−1,0,1,−1. The drive sequence having 1,0,−1,−1 can both prevent fouling and move the droplets. The pulse sequence having 1,0,0,0,−1 can both prevent fouling and hold the droplets for extended periods.

In another embodiment, there is provided an electrowetting system for actuating droplets of at least one composition, the system including: a plurality of electrodes configured to manipulate droplets of fluid in a microfluidic space, wherein each electrode is coupled to circuitry configured to selectively apply driving voltages to the electrode; and a processing unit operably connected to a storage medium, which may include a look up table (LUT) correlating drive sequences to composition identifying data, the processing unit being configured to: receive input data identifying the at least one composition; correlate a drive sequence with the data identifying the at least one composition; and output the drive sequence to the plurality of electrodes, to actuate a droplet of the at least one composition. In some embodiments, at least one of the drive sequences contains at least three consecutive positive pulses. The drive sequences may contain at least four consecutive positive pulses. In some embodiments, the drive sequence for driving the first composition can prevent fouling (e.g., reduce fouling and/or avoid fouling). The drive sequence can include at least one of 1,0,−1; 1,0,0,−1; 1,0,0,0,−1; 1,0,−1,−1; 1,−1,0,−1; 1,1,0,0,0,−1,−1; or 1,−1,0,1,−1. The drive sequence having 1,0,−1,−1 can both prevent fouling and move the droplets. The pulse sequence having 1,0,0,0,−1 can both prevent fouling and hold the droplets for extended periods.

### BRIEF DESCRIPTION OF DRAWINGS

FIG. 1A is a diagrammatic cross-section of the cell of an example EWoD device.

FIG. 1B illustrates EWoD operation with DC Top Plane.

FIG. 1C illustrates EWoD operation with top plane switching (TPS).

FIG. 1D is a schematic diagram of a TFT connected to a gate line, a source line, and a propulsion electrode.

FIG. 2 is a schematic illustration of an exemplary TFT backplane controlling droplet operations in an AM-EWoD propulsion electrode array.

FIG. 3A is a diagram schematically illustrating a system for storing and retrieving any number of reagent-specific drive schemes.

FIG. 3B is the flowchart of an exemplary method for correlating input droplet data to drive sequences to be output to DMF electrodes.

FIG. 3C is an exemplary set of drive sequences each specifically suited to a class of droplet composition.

FIG. 4 illustrates a charge-neutral pulse sequence.

FIG. 5 illustrates a non-impulse-balanced pulse sequence.

FIG. 6 illustrates a pulse sequence with a correcting, balancing pulse.

FIG. 7 shows a three-pixel neck actuated off a reservoir to cleave off a droplet.

FIG. 8 shows the formation of a neck two droplet diameters in length in order to successfully break off the droplet.

FIG. 9 schematically illustrates a droplet mixing pattern.

FIG. 10A shows the first step of a droplet mixing pattern.

FIG. 10B shows the droplet of FIG. 10BA after an elongating drive sequence is applied.

FIG. 10C illustrates the creation of an example weighted average drive sequence.

FIG. 11 includes the flow chart of a method of using drive profiles according to an exemplary embodiment.

FIG. 12 is a schematic illustration of drive sequences having different intermittency values.

FIG. 13A is a top view of a DMF device. A first reservoir is loaded with a solution of Tris-HCl 0.01 M in water (“No Tween”). A second reservoir includes the solution of the first reservoir modified by the addition of Tween 20 at a concentration of 0.05% (“0.05% Tween”).

FIG. 13B is the DMF of FIG. 13A pictured after about 1 hour of operation.

FIG. 13C is a picture taken after about 6 hours of operation.

FIG. 13D is a picture taken after about 24 hours of operation. FIG. 13E is a picture taken after about 25 hours of operation.

FIG. 14 is a top view of the DMF device of FIGS. 13A-13E after testing two different dispensing schemes.

FIG. 15 is an image of reagents being dispensed using different pulse sequences.

FIG. 16 is an image of reagents being dispensed using different pulse sequences. For the different positively biased pulse sequences shown, improved reagents dispensing is seen. Since these pulse sequences are unbalanced, long term damage from repeated use is expected.

FIG. 17 is an image of smaller dispense areas.

FIG. 18 is an image of reagents being dispensed using different pulse sequences.

FIG. 19 is an image of smaller dispense areas.

FIG. 20A illustrates pulse sequence design and droplet assignment to probe an influence of polarity biases on the degree of biofouling.

FIGS. 20B-20D illustrate results obtained by applying the pulse sequences shown in FIG. 20A on a device.

FIGS. 20E-20M illustrate results after disassembling the device shown in FIGS. 20B-20D.

FIGS. 20N-20O illustrate biofouling scores for the top glass and the device illustrated in FIGS. 20B-20M when different pulse sequences are used.

FIG. 21A illustrates pulse sequence design and droplet assignment.

FIGS. 21B-21C illustrate dispense patterns of CFPS and Wash-2 droplet.

FIGS. 21D-21F illustrate incubation and protein expression levels after the dispense is carried out illustrated in FIGS. 21B-21C.

FIG. 21G illustrates withdrawal of droplets back into original reservoirs using the pulse sequence (1,−1).

FIGS. 21H-21J illustrate protein expression levels after washing the device illustrated in FIGS. 21B-21G.

FIG. 22A illustrates pulse sequence design and droplet assignment.

FIGS. 22B-22D illustrate loading patterns using different reagents.

FIG. 22E illustrates an incubation pattern actuated by the pulse sequences (1,−1) and (1,0,0,0,−1) 2120 for 24 hours.

FIG. 22F illustrates a post incubation pattern.

FIGS. 22G-22H are images captured by the Basler camera of the whole panel.

FIG. 22I is a linescan illustrating biofouling on the panel over the column of standards.

FIGS. 23A-23B illustrate dispense patterns using the pulse sequence (1,−1).

FIGS. 23C-23D illustrate dispense patterns using the pulse sequences (1,−1) and (1,0,0,0,−1) and using Facade-TFA1 and F 127 as the surfactant phase.

FIGS. 23E-23F illustrate that droplet populations using the pulse sequences (1,−1) and (1,0,0,0,−1) and using Facade-TFA1 and F 127 as the surfactant phase after the device is drained.

FIGS. 23G-23J illustrate fouling patterns over the 4 quadrants of different surfactant-actuation combinations.

FIGS. 23K-23N are images illustrating fouling patterns for TFT and top glass using the pulse sequences (1,−1) and (1,0,0,0−1) on F127 after the top glass is opened.

FIGS. 230-23R are images illustrating fouling patterns for the TFT and the top glass using pulse sequences (−1, 1) and (1,0,0,0,−1) on Facade-TFA1 after the top glass is opened.

FIGS. 24A-24B illustrate dispense and placement patterns of a panel for 0 hour and 12 hours.

FIGS. 24C-24F are images illustrating a uniform temperature distribution over a surface of a slide warmer as well as a device at room temperature (RT) and an elevated temperature of 50° C.

FIGS. 24G-24H illustrate droplet populations using the pulse sequences (1,0,0,0,−1) and (1,−1) at RT and at the elevated temperature of 50° C.

FIG. 24I illustrates biofouling scores for the droplet populations using the pulse sequences (1,0,0,0,−1) and (1,−1) at RT and at the elevated temperature of 50° C.

FIGS. 25A-25B illustrate a panel design such that half the panel being actuated with either waveform can be either incubated in place or can be being moved in a circulatory pattern, giving a unique combination of pulse sequence and incubation pattern in each quadrant.

FIG. 25C illustrates a dispense pattern using pulse sequences (1,−1) and (1,0,−1,−1) on a panel.

FIGS. 25D-25E illustrate line scans taken through a diagonal dimension of each reservoir in the left-side panel.

FIG. 25F illustrates line scans through the reservoirs for moving droplets.

FIGS. 25G-25H illustrate line scans across the panel where the reservoirs are actuated by the pulse sequences (1,0,−1,−1) and (1,−1) in place for 0 h and 3 h.

FIG. 25I illustrates a dispense performance of the magnetic beads applied by the pulse sequences (1,0,−1,−1) and (1,−1).

FIG. 26A illustrates a layout for pulse sequence design and droplet movements.

FIG. 26B illustrates droplet distribution dispensed by the pulse sequences (1,0,−1,−1) and (1,−1).

FIGS. 26C-26D illustrate expression levels caused by the pulse sequences (1,0,−1,−1) and (1,−1).

FIG. 26E is an binary thresholded image illustrating salt deposition/biofouling pattern when the pulse sequences (1,−1) and (1,0,−1,−1) are applied.

FIG. 26F is a table illustrating a biofouling score for the pulse sequences (1,−1) and (1,0,−1,−1), and noise floor.

FIG. 27A illustrates a layout for pulse sequence design and droplet assignments.

FIG. 27B illustrates an actuation screen using lysate.

FIG. 27C illustrates a droplet array where the set of pulse sequences are applied.

FIG. 27D illustrates lysate droplets actuated by the set of pulse sequences.

FIG. 27E illustrates CFPS droplets actuated by the set of pulse sequences.

FIG. 27F illustrates a biofouling map for lysate actuated by the set of pulse sequences.

FIG. 27G illustrates a biofouling map for CFPS actuated by the set of pulse sequences.

FIG. 27H illustrates line scans across the biofouling map for CFPS.

FIG. 28 is a block diagram of an exemplary computing device that can be used to perform one or more steps of the methods provided by exemplary embodiments.

### DEFINITIONS

Unless otherwise noted, the following terms have the meanings indicated.

“Actuate” or “activate” with reference to one or more electrodes means effecting a change in the electrical state of the one or more electrodes which, in the presence of a droplet, results in a manipulation of the droplet. Activation of an electrode can be accomplished using alternating current (AC) or direct current (DC). Where an AC signal is used, any suitable frequency may be employed.

“Droplet” means a volume of liquid that electrowets a hydrophobic surface and is at least partially bounded by carrier fluid and/or, in some instances, a gas or gaseous mixture such as ambient air. For example, a droplet may be completely surrounded by carrier fluid or may be bounded by carrier fluid and one or more surfaces of an EWoD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWoD device. Droplets may include typical polar fluids such as water, as is the case for aqueous or non-aqueous compositions, or may be mixtures or emulsions including aqueous and non-aqueous components. Droplets may also include dispersions and suspensions, for example magnetic beads in an aqueous solvent. In various embodiments, a droplet may include a biological sample, such as whole blood, lymphatic fluid, scrum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes. In further examples, the droplet contents may include reagents for peptide and protein production, for example by chemical synthesis, expression in living organisms such as bacteria or yeast cells or by the use of biological machinery in in vitro systems.

The terms “DMF device”, “EWoD device”, and “Droplet actuator” mean a device for manipulating droplets.

“Droplet operation” means any manipulation of one or more droplets on a microfluidic device. A droplet operation may, for example, include: loading a droplet into the DMF device; dispensing one or more droplets from a source reservoir; splitting, separating or dividing a droplet into two or more droplets; moving a droplet from one location to another in any direction; merging or combining two or more droplets into a single droplet; diluting a droplet; mixing a droplet; agitating a droplet; deforming a droplet; holding a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge.” “merging.” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B.” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations includes but is not limited to microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Gate driver” is a device directing a high-current drive input for the gate of a high-power transistor such as a TFT coupled to an EWoD pixel electrode. “Source driver” is a device directing a high-current drive input for the source of a high-power transistor. “Top plane common electrode driver” is a power amplifier producing a high-current drive input for the top plane electrode of an EWoD device.

“Drive sequence” or “pulse sequence” denotes the entire voltage against time curve used to actuate a pixel in a microfluidic device. Often, as illustrated below, such a sequence may comprise a plurality of elements; where these elements are essentially rectangular (i.e., where a given element comprises application of a constant voltage for a period of time), the elements may be called “voltage pulses” or “drive pulses”. The term “drive scheme” denotes a set of one or more drive sequences sufficient to effect one or more manipulations on one or more droplets in the course of a given droplet operation. The term “frame” denotes a single update of all the pixel rows in a microfluidic device. In the example herein the number 1 denotes a positive voltage, and minus 1 denotes a negative voltage. Zero indicates a time gap where no voltage is applied.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix, or surface, such liquid could be either in direct contact with the electrode/array/matrix/surface, or could be in contact with one or more layers or films that are interposed between the liquid and the electrode/array/matrix/surface.

When a droplet is described as being “in”, “on”, or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

“Each,” when used in reference to a plurality of items, is intended to identify an individual item in the collection but does not necessarily refer to every item in the collection. Exceptions can occur if explicit disclosure or context clearly dictates otherwise.

### DETAILED DESCRIPTION

In one embodiment, the present application relates to novel, adaptable EWoD devices which are programmed to individually tailor their drive schemes to different droplet contents and other variables. Also provided are programmable processing and control units for operating the devices. From an operational standpoint, the data processing steps associated with this novel approach usually include: (i) determining which pixels are occupied by droplets; (ii) ascertaining which composition of matter occupies the area of one or more pixels, and (iii) what types of pulse sequences, if any, are to be applied to the droplets. As such, the voltage and duration of each driving pulse may be chosen on the basis of variables including droplet composition, droplet location on the array, and the operation to be performed. The ability to adjust the way a droplet is handled to suit a variety of chemical and biological reagents and products enables the device to bring to completion each desired droplet operation. In various embodiments, the invention is applicable to either open or closed architectures and may be implemented in segmented and active matrix devices alike, including but not only AM-EWoD systems where the transistors of the matrix are TFT. In one embodiment, the device is used to perform a number of different chemical or biological assays and is provided with access to memory storing programmable instructions specifically suited to each of the reagent compositions used in each of the assays.

In one embodiment, there is provided an electrowetting system for actuating different droplet compositions using different pulse sequences. A balance may be found between pulse sequences which are effective to move droplets, but which to not harm the array of electrodes. A pulse sequence may be a charged balanced sequence alternating 1, −1. Such a sequence minimizes harm the array, but may not be sufficient to move all droplet compositions. Droplets which are for example more visco-elastic, have a high ionic strength or a high concentration of polymeric reagents may be harder to move or split. Therefore a pulse sequence having a string of pulses, for example three or four consecutive pulses of the same charge may be used. However such charge build-up harms the array, and is not ideal unless necessary. Thus the use of repetitive pulses may be used where needed by certain droplet reagents, but is not needed for each droplet on the array.

The pulse sequence may be selected from
1, 1, 1, 0;
1, 1, 1, 0, 1, −1, 0;
1, 1, 1, 1, 0;
1, 1, 1, 1, 0, 1, −1, 0;
1, 1, 1, 1, −1, −1, −1, −1;
1,0,−1;
1,0,0,−1;
1,0,0,0,−1;
1,0,−1,−1;
1,−1,0,−1;
1,1,0,0,0,−1,−1; or
1,−1,0,1,−1;

The pulse voltage may be +15 V for each positive pulse and −15V for each negative pulse.

The droplets may be driven with a drive sequence which is a balanced sequence alternating 1, −1.

The electrowetting system may use a first pulse sequence comprising at least one of:
1, 1, 1, 0;
1, 1, 1, 0, 1, −1, 0;
1, 1, 1, 1, 0;
1, 1, 1, 1, 0, 1, −1, 0;
1, 1, 1, 1, −1, −1, −1, −1
1,0,−1;
1,0,0,−1;
1,0,0,0,−1;
1,0,−1,−1;
1,−1,0,−1;
1,1,0,0,0,−1,−1; or
1,−1,0,1,−1;
and a second drive sequence which is a balanced sequence alternating 1, −1.

Disclosed is a method for performing droplet operations on a first composition and a second composition in an electrowetting system, the electrowetting system comprising a plurality of electrodes configured to manipulate droplets of fluid in a microfluidic space, wherein each electrode is coupled to circuitry configured to selectively apply driving voltages to the electrode; and
driving the first composition with a pulse sequence of driving voltages which contains at least three consecutive positive pulses or is positively biased or at least one of 1,0,−1; 1,0,0,−1; 1,0,0,0,−1; 1,0,−1,−1; 1,−1,0,−1; 1,1,0,0,0,−1,−1; or 1,−1,0,1,−1; and driving the second composition with a charge-neutral drive sequence alternating 1, −1.

### Gate Line Addressing

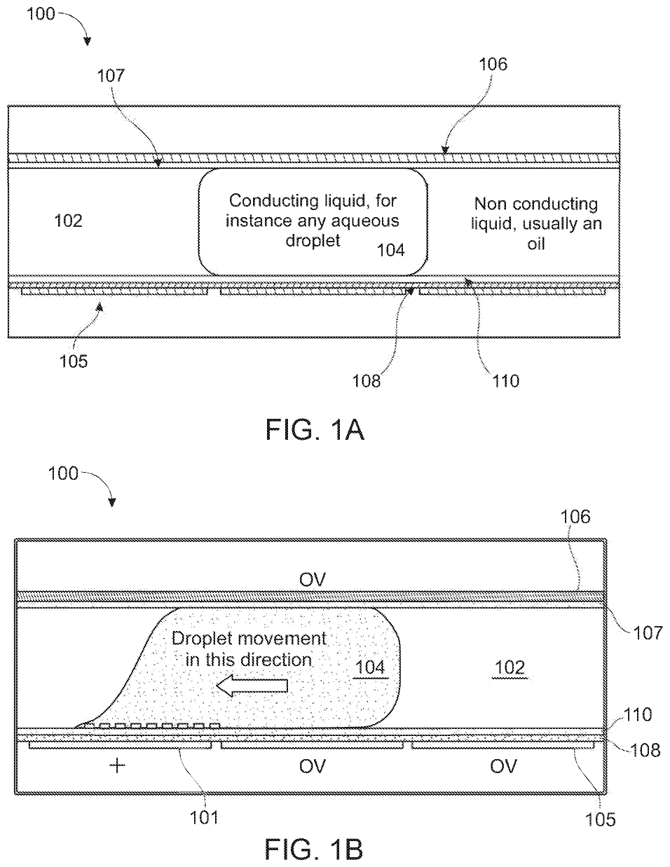

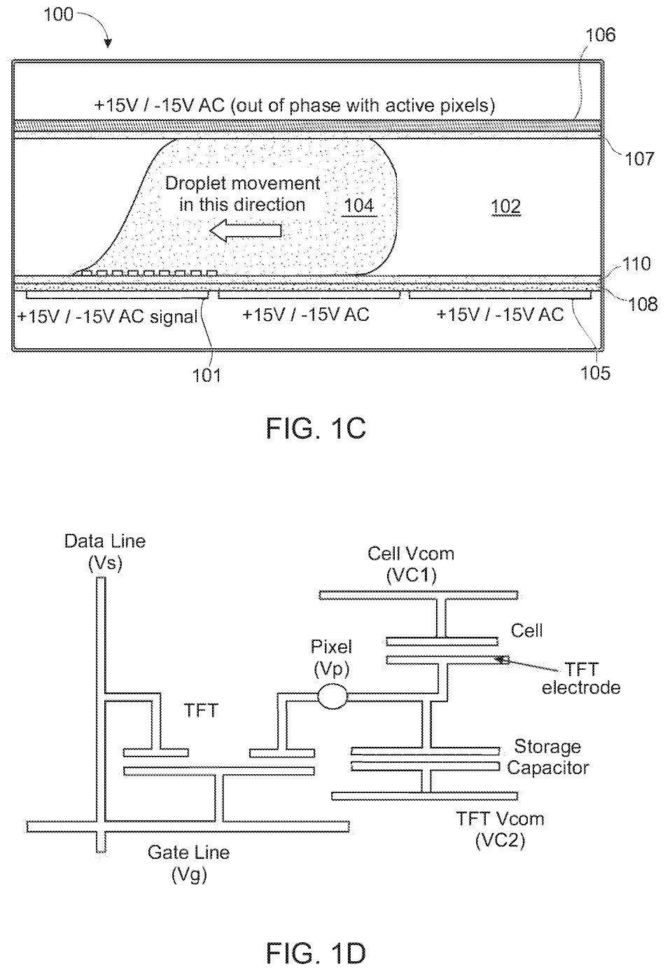

FIG. 1A shows a diagrammatic cross-section of the cell 100 in an example traditional closed EWoD device where droplet 104 is surrounded on the sides by carrier fluid 102 and sandwiched between top hydrophobic layer 107 and bottom hydrophobic layer 110. Propulsion electrodes 105 under dielectric layer 108 can be directly driven or switched by transistor arrays arranged to be driven with data (source) and gate (select) lines, much like an active matrix in liquid crystal displays (LCDs) and organic light emitting diodes (OLEDs), resulting in what is known as active matrix (AM) EWoD. Typical cell spacing is usually in the range of about 50 μm to about 500 μm.

There are two main modes of driving closed system EWoDs: “DC Top Plane” and “Top Plane Switching (TPS)”. FIG. 1B illustrates EWoD operation in DC Top Plane mode, where the top plane electrode 106 is set to a potential of zero volts, for example by grounding. As a result, the potential applied across the cell is the voltage on the active pixel, that is, pixel 101 having a different voltage to the top plane so that conductive droplets are attracted to the electrode. In active matrix TFT devices, this limits pixel driving voltages in the EWoD cell to about ±15 V because in commonly used amorphous silicon (a-Si) TFTs the maximum voltage is in the range from about 15 V to about 20 V due to TFT electrical instabilities under high voltage operation.

FIG. 1C shows driving the cell with TPS, in which case the driving voltage is doubled to ±30 V by powering the top electrode out of phase with active pixels, such that the top plane voltage is additional to the voltage supplied by the TFT.

Amorphous silicon TFT plates usually have only one transistor per pixel, although configurations having two or more transistors are also contemplated. As illustrated in in FIG. 1D, the transistor is connected to a gate line, a source line (also known as “data line”), and a propulsion electrode. When there is large enough positive voltage on the TFT gate then there is low impedance between the source line and pixel (Vg “ON”), so the voltage on the source line is transferred to the electrode of the pixel. When there is a negative voltage on the TFT gate then the TFT is high impedance and voltage is stored on the pixel storage capacitor and not affected by the voltage on the source line as the other pixels are addressed (Vg “OFF”). If no movement is needed, or if a droplet is meant to move away from a propulsion electrode, then 0 V, that is, no voltage differential relative to the top plate, is present on the pixel electrode. Ideally, the TFT should act as a digital switch. In practice, there is still a certain amount of resistance when the TFT is in the “ON” setting, so the pixel takes time to charge. Additionally, voltage can leak from Vs to Vp when the TFT is in the “OFF” setting, causing cross-talk. Increasing the capacitance of the storage capacitor Cₛ reduces cross-talk, but at the cost of rendering the pixels harder to charge.

The drivers of a TFT array receive instructions relating to droplet operations from a processing unit. The processing unit may be, for example, a general purpose computer, special purpose computer, personal computer, or other programmable data processing apparatus providing processing capabilities, such as storing, interpreting, and/or executing software instructions, as well as controlling the overall operation of the device. The processing unit is coupled to a memory which includes programmable instructions to direct the processing unit to perform various operations, such as, but not limited to, providing the TFT drivers with input instructions directing them to generate electrode drive signals in accordance with embodiments herein. The memory may be physically located in the DMF device or in a computer or computer system which is interfaced to the device and hold programs and data that are part of a working set of one or more tasks being performed by the device. For example, the memory may store programmable instructions to carry out the drive schemes described in connection with a set of droplet operations. The processing unit executes the programmable instructions to generate control inputs that are delivered to the drivers to implement one or more drive schemes associated with a given droplet operation.

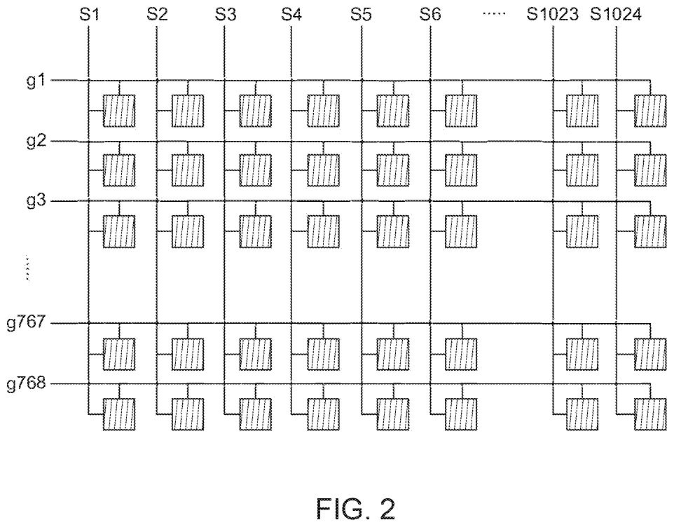

FIG. 2 is a diagrammatic view of an exemplary TFT backplane controlling droplet operations in an AM-EWoD propulsion electrode array. In this configuration, the elements of the EWoD device are arranged in the form of a matrix as defined by the source lines and the gate lines of the TFT array. The source line drivers provide the source levels corresponding to a droplet operation. The gate line drivers provide the signals for opening the transistor gates of electrodes which are to be actuated in the course of the operation. The figure shows the signals lines only for those data lines and gate lines shown in the figure. The gate line drivers may be integrated in a single integrated circuit. Similarly, the data line drivers may be integrated in a single integrated circuit. The integrated circuit may include the complete gate and source driver assemblies together with a controller. Commercially available controller/driver chips include those commercialized by Ultrachip Inc. (San Jose, California), such as UC8152, a 480-channel gate/source programmable driver. The matrix of FIG. 2 is made of 1024 source lines and a total of 768 gate lines, although either number may change to suit the size and spatial resolution of the DMF device. Each element of the matrix contains a TFT of the type illustrated in FIG. 1D for controlling the potential of a corresponding pixel electrode, and each TFT is connected to one of the gate lines and one of the source lines.

### Reagent-Specific Drive Profiles

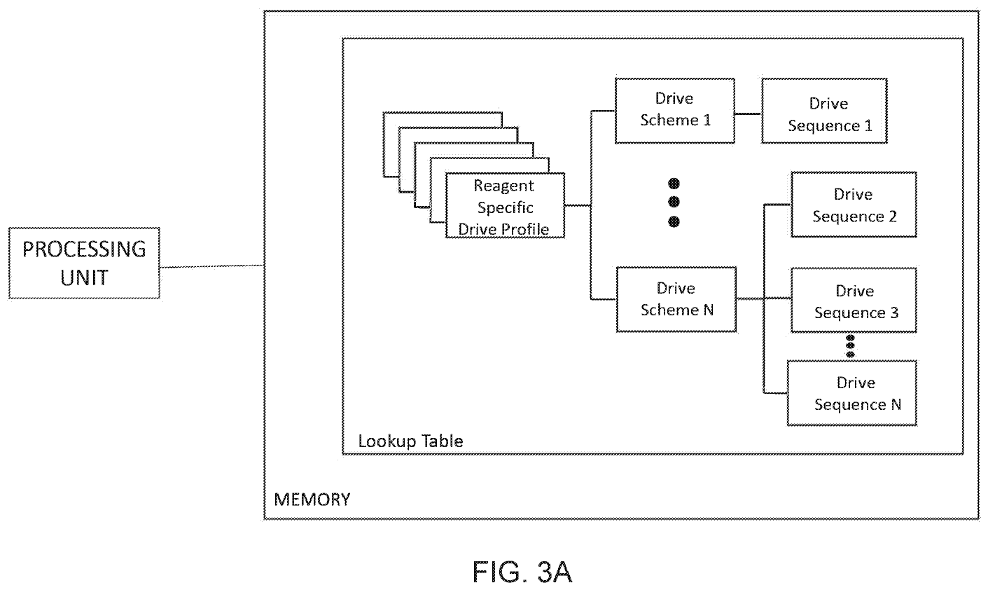

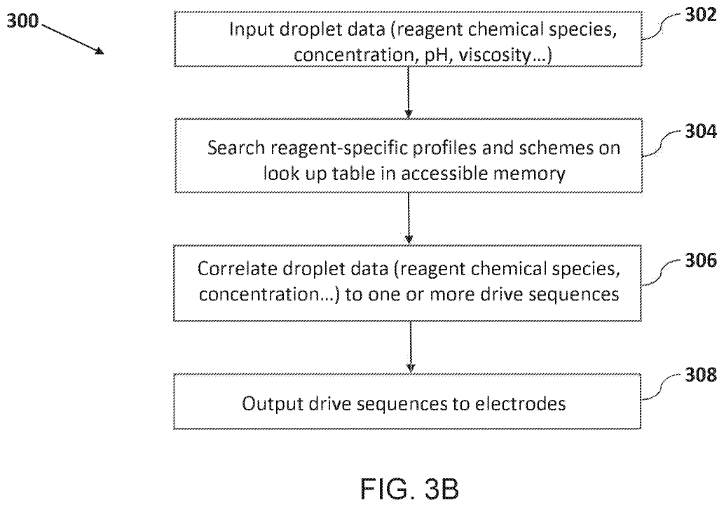

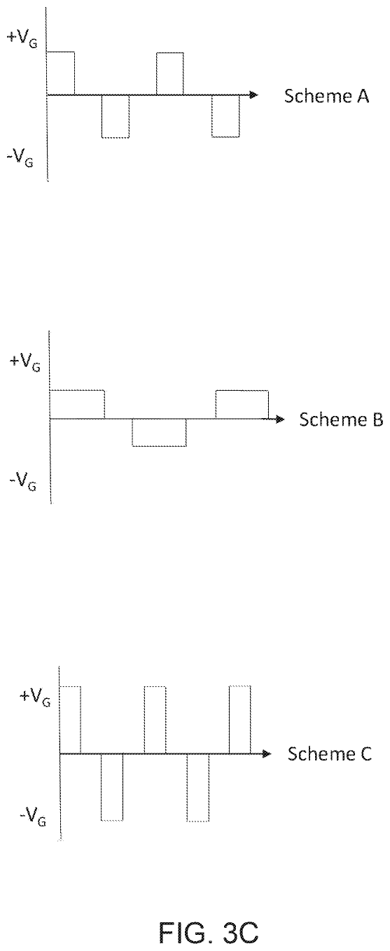

As mentioned above, this application relates to adaptable DMF devices programmed to implement sets of drive schemes which are specifically tailored to individually suit one or more of any number of differing droplet compositions and composition parameters. FIG. 3A is a block diagram schematically illustrating an example system for storing reagent-specific drive schemes. The processing unit is operatively coupled to a memory in which a searchable lookup table or other searchable data structure is held. The memory stores reagent-specific drive profiles are stored. The memory can also store programmable instructions executed by the processing unit to carry out operations described herein. Each profile includes one or more drive schemes which may be specifically tailored to the properties of a given reagent. More broadly, the term “reagent-specific drive profile” extends to profiles applicable to any composition manipulated in the DMF device, including a reagent at a particular concentration, a mixture of two or more reagents, and/or one or more reaction products. Included in the lookup table may also be one or more tuning functions or tables for adapting the drive schemes of a profile to suit the temperature of the DMF device or any of its parts, ambient humidity, and other extrinsic variables which may affect droplet operations. Other reagent-specific drive profiles may depend upon, e.g., the type of carrier fluid, the pH of the reagent, viscosity of the reagent, or the ionic concentration of the reagent.

The lookup table may be held in the form of a file system or located in virtual memory associated with one or more computer systems and may be arranged in a variety of ways, such as physically located inside the computer system, directly attached to the CPU bus, attached to a peripheral bus, or located in a cloud-based storage platform that is operably connected to the computer system. For each new reagent, mixture, or product taking part in a droplet operation, a suitable reagent-specific profile is chosen from among those available within the table. A reagent-specific profile may include composition parameters such as pH, temperature, rheological properties such as viscosity, ionic strength, electrical conductivity, and absorbance at particular wavelengths, among other parameters relevant to the electrowetting response of the corresponding reagent. Prior to or at the beginning of a droplet operation, drive schemes from the profile or relevant portions thereof may be loaded into a temporary memory for subsequent use by the processing unit.

The mobility of a droplet in a microfluidic space is affected by parameters including but not limited to: reagent concentration in the droplet solvent, e.g. water, ionic strength, concentration and chemistry of surfactant additives, droplet rheology, reagent charge which in turn may be affected by the pH of the droplet, and temperature or temperature gradients within the device. Prior to reagent use, these and other properties may be measured for each reagent type and a determination made as to which drive profile, typically, will be best suited to a given reagent or mixture. Alternatively, droplets of the reagent may be directly tested on a DMF device by applying each of the available drive profiles until the profile with the best performance is found and labelled with a code or other identifying data matching the profile to the reagent for future use. Thereafter, for all subsequent manipulations of the reagent in the DMF device, a user can specify which drive profile is to be used at a particular location in the device.

FIG. 3B is a flowchart illustrating an example method 300 for operating an electrowetting system with the sequence drives saved to the reagent-specific drive profiles. The method 300 can be performed using the processing unit of the electrowetting system. At block 302, the processing unit receives droplet data. For example, the processing unit receives data pertaining to the characteristics of a droplet to be actuated in the system. The data usually includes the identity of chemicals species contained in the droplet, e.g., one or more reagents delivered in the droplet, the respective concentrations of relevant chemical species, and/or other composition parameters related to a chemical species concentration or affecting droplet mobility and chemistry, for example pH, temperature, rheological properties such as viscosity, ionic strength, electrical conductivity, and absorbance at particular wavelengths. At block 304, the processing unit then searches reagent-specific profiles in the look up table. At block 306, the processing unit correlates relevant droplet data, such as which reagent chemical species it contains and their respective concentrations, to one or more drive sequences. At block 308, the processing unit outputs the drive sequences to the electrodes of the electrowetting system.

Droplets of each reagent may be actuated with drive sequences specifically suited to their characteristics. This novel capability is especially advantageous because implementing the same drive scheme for different chemical compositions may result in sub-optimal droplet actuation on one or more of the compositions. In addition, voltage ranges and impulse lengths suitable for one composition may induce undesired electrochemical reactions in another. This in turn may lead to further reactions leading to corrosion of the working surfaces of the DMF device. To take a representative example, as illustrated in FIG. 3C, Drive Scheme A performs satisfactorily when applied to a first Reagent 1 but leads to corrosion on the working surfaces when applied to a second Reagent 2. This problem is solved by driving droplets containing Reagent 2 with Scheme B having pulses of longer duration but lower voltage than Scheme A. In contrast, droplets containing a third Reagent 3 move slowly and sluggishly when actuated with either Scheme A or B. However, Scheme C, which is characterized by pulse sequences of higher voltages, is found to remedy this problem without upsetting the chemistry of Reagent 3 or causing corrosion.

In another, non-exclusive embodiment, a complete reagent drive profile is custom-made for each individual reagent type and added to the look up table. Each reagent is run through moving, splitting, dispensing, mixing and holding tests spanning a broad set of voltages, polarities, and pulse durations to identify drive schemes having pulse sequences best suited to that reagent. This customized reagent profile is then be added to the look up table and matched to one or more reagents by a code or other labelling item of information, to be called by the processing unit whenever that reagent is to be used on the DMF device. The number of reagent (and, as explained above, any mixtures of two or more reagents and/or products) profiles stored in the look up table would then be up to the number of reagents or mixtures that have reagent drive profiles determined therefor. A user may specify a code or other labeling item of information associated with which reagent is to be used at a particular location in the DMF device. In one embodiment, there is not a finite standard set of reagent profiles from which to choose the one best suited to a droplet. Instead, a specific reagent drive profile may generated individually for each new reagent.

For certain classes of droplet compositions, suitable drive profiles are already well-known and no data regarding chemical species or composition parameters are required for selecting appropriate drive sequences. An example is provided by standardized buffered aqueous solutions serving as solvents and other roles in biochemical or biomolecular applications, e.g., nucleic acid amplification, affinity-based assays, enzymatic assays, gene sequencing, protein sequencing, peptide and protein synthesis, and/or analyses of biological fluids, where the buffers are often sourced in bulk from commercial providers. In such instances, more expedited processing may be achieved by marking or labeling a standardized composition with a code or other identifying data matching the composition to a pre-selected drive profile in the look up table. When droplets of the standardized composition are to take part in a droplet operation, the processing unit correlates the identifying data to one or more drive sequences in the pre-selected drive profile. As the standardized composition and the drive profile have been already matched, there is no longer a need for the processing unit to search the look up table for drive profiles and select drive sequences fitting the chemical species and parameters of the standardized composition.

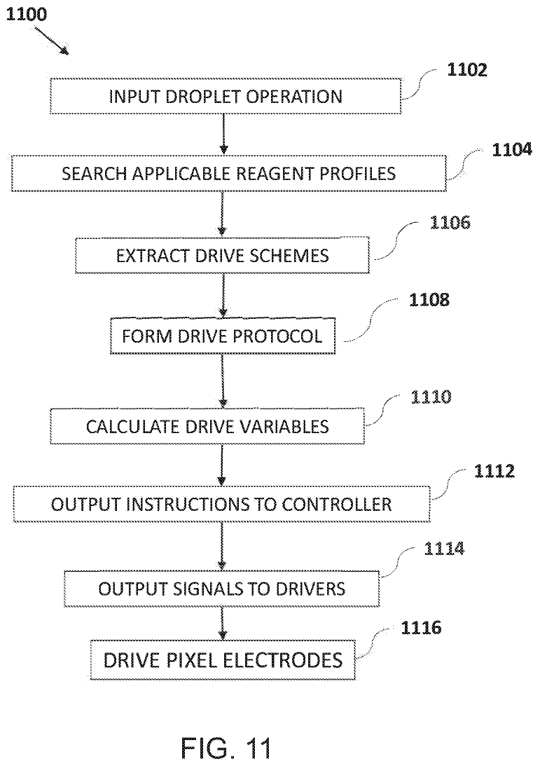

FIG. 11 includes the flow chart (1100) of a method of using the drive profiles according to an exemplary embodiment. The method 1100 can be performed using an electrowetting system At block 1102, the processing unit of the electrowetting system receives a desired droplet operation (e.g., from a user input). At block 1104, the processing unit is programmed to search for and identify applicable reagent profiles in the look up table. At block 1106, the processing unit extracts drive schemes. For example, the processing unit is programmed to select from the profiles one or more drive schemes which are best-suited to the compositions, e.g., reagents, products, and/or mixtures, which are to be manipulated in the operation. At block 1108, the processing unit forms a drive protocol. For example, the processing unit combines the drive sequences of the schemes together to form a driving protocol that is executed to implement the droplet operation. At block 1110, the processing unit calculates drive variables. For example, the processing unit calculates drive variables relating to the drive sequences such as the polarity, frequency, and amplitude of each of the pulses of the corresponding voltage sequences are calculated). At block 1112, the processing unit outputs instructions to a controller. At block 1114, the controller of the electrowetting system outputs signals to the drivers At block 1116, the drivers of the electrowetting system drives pixel electrodes. For example, the drivers drive the pixel electrodes by affecting a voltage at particular pixel electrodes as a function of time.

### Drive Schemes

A given droplet operation may require drive schemes of differing levels of complexity depending on the number of manipulations associated with that droplet operation. To this end, included in each reagent-specific drive profile of the look up table are a set of drive schemes to facilitate droplet operations. Example droplet operations include those outlined above, namely: loading a droplet into the DMF device; dispensing one or more droplets from a reservoir; splitting, separating or dividing a droplet into two or more droplets; moving a droplet from one location to another in any direction; merging or combining two or more droplets into a single droplet; diluting a droplet; mixing a droplet; agitating a droplet; deforming a droplet; holding a droplet in position; incubating a droplet; heating a droplet; cooling a droplet; disposing of a droplet; transporting a droplet out of a DMF device; and/or any combination of the foregoing.

The data needed to define a set of drive sequences which are applied in the course of a given droplet operation is stored in the form of a drive scheme which is matched to the operation. A drive scheme may include any from just one to a large number of drive sequences, depending on the requirements and complexity of the operation. In some instances, it may be preferable to store multiple sets of drive sequence data to allow for variations in environmental variables such as temperature and humidity. Alternatively, a drive scheme may include tuning functions which are applied to change one or more coefficients defining its drive sequences to suit different environmental conditions.

According to a representative embodiment, there is provided an exemplary drive scheme, hereinafter referred to as “motion scheme”, which is implemented in a DMF device for moving droplets of a given composition from one location to another. The scheme includes one or more drive sequences specifying the magnitude, duration, polarity, and other relevant characteristics of pulses that are applied to actuate composition droplets. Other relevant data may also be included in the scheme, for example the speed of movement of the pixels, meaning how quickly the applied voltage profile moves from one set of pixels currently occupied by the droplet to an adjacent set of pixels currently unoccupied by the droplet, where the droplet will move to next and how quickly to change the voltage on the trailing edge of the droplet to force the droplet off the previous location. For a drop of size matching a single pixel this is straightforward, i.e., activating the location to move toward and turning off the currently occupied pixel and other adjacent pixels. For drops having a footprint occupying multiple pixels, the variation in geometric pattern, number, and timing of pixels being turned on and off are all parameters that may be optimized to suit any type of droplet composition. In one representative example, a motion scheme for deionized water with a surfactant, for example 0.05 wt % Tween 20, includes a 50 Hz square wave alternating pulse sequence at +/−30 V. The pulse sequence may be generated on a TFT array and top plane switching (TPS) to reverse the polarity.

The application of drive pulses to a pixel may result in deleterious side effects resulting from the accumulation of residual charge on the pixel surface which is apt to cause unwanted electrochemical reactions and/or surface and electrode degradation. One approach that may be taken for minimizing damage to the EWoD device involves ensuring that a given drive scheme is charge-neutral, in the sense that, for any arbitrary series of pulses in a drive scheme, the overall change in charge surface density is equal to zero. When the overall drive scheme of a droplet operation is charge-neutral, and even more when all drive sequences of the scheme are each individually charge-neutral, the chance for electrochemical damage to the pixel surface and the underlying electrodes is minimized.

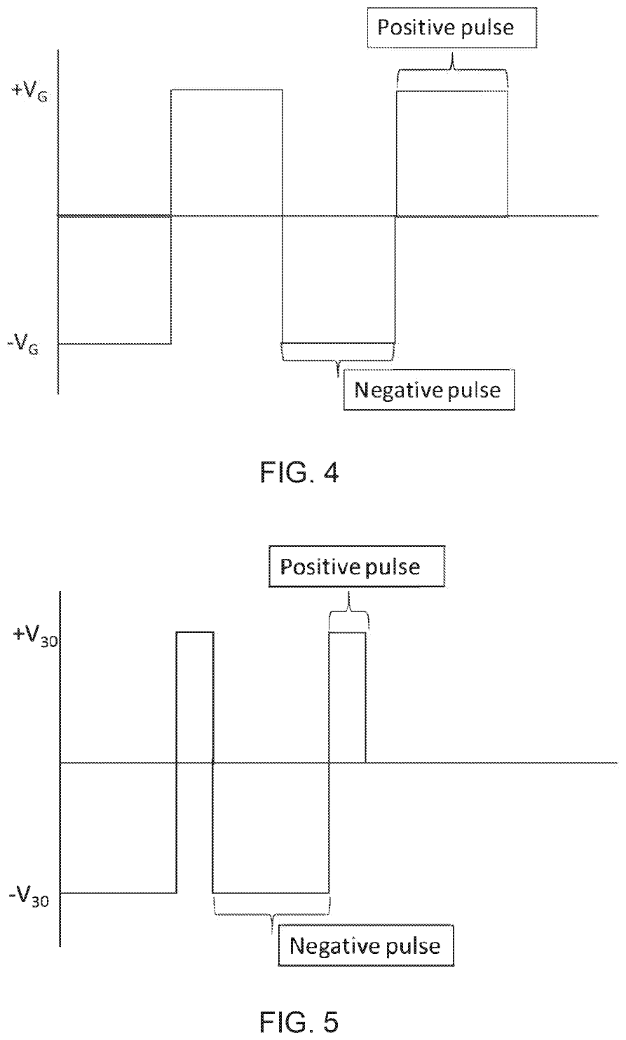

As a starting point and first approximation, charge neutrality may be attempted by ensuring that a given drive scheme is “impulse-balanced” in the sense that, for any arbitrary series of pulses in a drive sequence belonging to the scheme, the overall applied impulse (i.e., the integral of the applied voltage with respect to time) equals zero. This is exemplified in FIG. 4 where the number and duration of positive and negative pulses are equal. There are other ways to zero the impulse in the device where the number and duration of pulses may not be the same but the sum of the products of the voltage and duration for each positive pulse is equal to the same sum of products for the negative driving pulses. However, for many reagents, impulse-balanced pulses may not be charge-neutral in that they still leave residual charges on the surface due to asymmetric effects of positive- and negative-voltage pulses. In such instances, additional positive or negative correcting pulses beyond impulse balance may be applied to obtain charge balance on the surface. In a representative example, a first attempt is made by applying an impulse-balanced drive scheme followed by measuring the amount of residual surface charge by one of the methods known to those skilled in the art. If unacceptable surface charge densities are detected, corrective pulses may be added in further iterations until charge balance is reached, thereby creating an impulse-imbalanced, yet charge-neutral drive sequence. This approach ensures that the residual charge experienced by any pixel of the DMF device is null or at least bounded by a known value, regardless of the exact series of transitions undergone by that pixel.

It should also be noted that, for more complex reagents and reagent combinations, it may not be always possible to attain a desired droplet motion by applying fully impulse-balanced drive schemes or even single drive sequences. This may occur especially with aqueous mixtures containing enzymes, nucleic acid molecules like DNA or RNA polynucleotides, natural or synthetic polymeric materials, and colloids such as functionalized magnetic beads. For example, time-sensitive reaction profiles may require reagent droplets to change locations at speeds only attainable with pulse-imbalanced drive schemes or sequences. In some embodiments, a drive sequence that would not be impulse-neutral after each pair of pulses is provided in the form of what is known as “pulse width modulated” (PWM) repeating signal. In this example, the negative pulses are the same number as the positive pulses, but longer in duration. The net result over time imparts a negative impulse to the pixel surface, as illustrated in FIG. 5. In other embodiments, the PWM includes changing the balance of pulses and rests to change the effective impulse over time and may also change the net impulse balance if the frequency of pulses of one polarity is higher than the frequency of the other polarity.

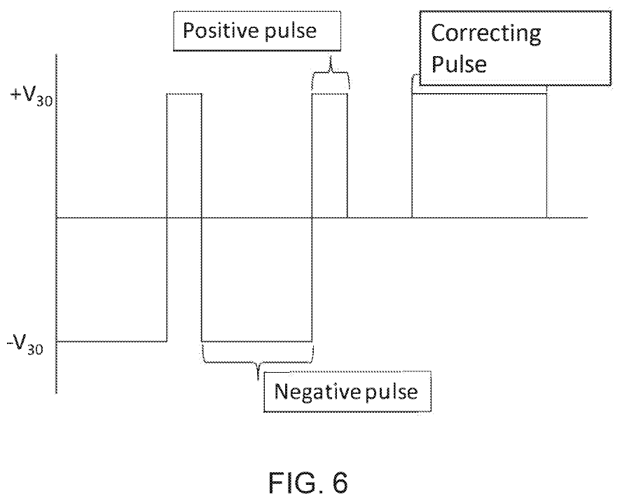

In instances where impulse imbalance is accompanied by undesired surface charge buildup, the disparity in pulse duration positive and negative will create a trade-off between enhanced movement for the reagent and the likelihood of electrochemical damage to the EWoD device. Depending on the magnitude of the residual charge over time, the device may sustain electrochemical damage that becomes irreversible. To solve or at least ameliorate this drawback, one or more charge-correcting pulses of the opposite polarity, sufficient to remove residual charge partially or fully, may be added to either the beginning of the drive sequence, before the droplet has started to move, or to the end of the sequence, after the droplet has been moved to the new location. This type of correcting pulse is shown in FIG. 6. After a drop has been moved to a location and the surrounding pixels have been turned off, almost any correcting pulse can be used and not move the droplet. As such, more complex sequences of correcting pulses can be used to create a charge-neutral pulse sequence, and pulses of different voltages can also serve as correcting tools.

In a further embodiment, another exemplary scheme, hereinafter referred to as “dispensing scheme”, is provided for dispensing droplets of a desired reagent from a reservoir. This type of schemes are usually characterized by drive sequences of a more complex nature than the aforementioned motion schemes and may require additional information to be fully applicable to each reagent or reagent mixture. However, information on droplet mobility that is derived from motion schemes may still prove useful in selecting drive schemes best suited to dispensing droplets of the same or similar composition.

A dispensing scheme is applied to move reagent aliquots from a reservoir volume to form an actuated neck. A droplet is cleaved off, and the fluid of the neck is returned to the reservoir. The length of the actuated neck needed before a drop can be successfully cleaved from the head of the neck may be reagent-dependent. The dispensing profile may specify actuated neck lengths expressed in terms of numbers of pixels and durations of time required to elapse before a droplet can be safely assumed to have fully separated from the reservoir. For the aforementioned droplets of water with Tween 20 at a concentration of 0.05 wt %, a neck length of 3 pixels and a time interval of 500 ms are usually sufficient to cleave off the droplet.

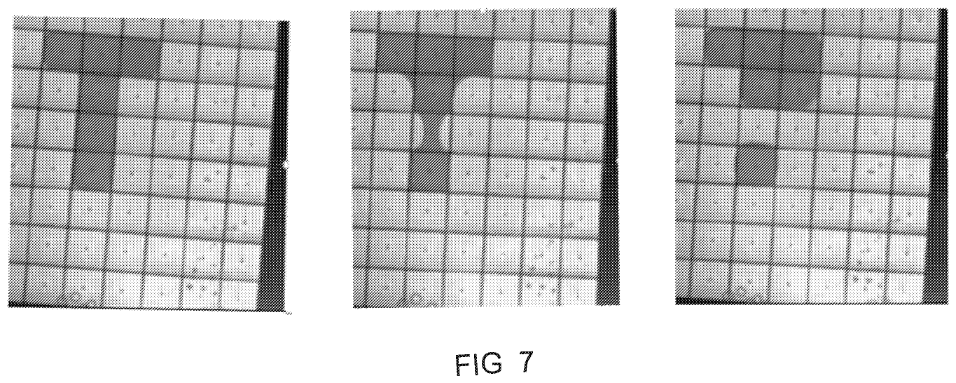

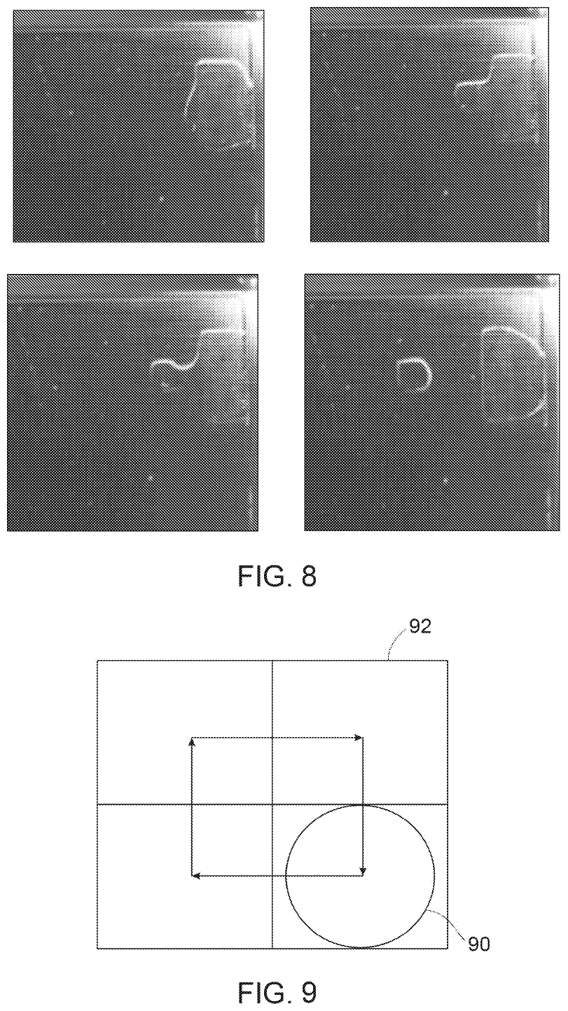

FIG. 7 shows a three-pixel neck actuated off a reservoir by actuation of pixel electrodes in a PM-EWoD device. In direct drive configurations, the footprint of each droplet usually covers the area of one pixel. As such, the process of neck formation is controlled at a resolution of about one pixel diameter. This neck length allows a droplet to be cleaved off from the neck head on a segmented DMF device. Hence, it can measure the length of the actuated neck in terms of approximate number of droplet diameters. In the example shown in FIG. 8, water with Tween 20 surfactant at a concentration of 0.05 vol % is extended to form a neck on an AM-EWoD device having a TFT array. In a TFT-based architecture, the droplet can be much larger than a single pixel electrode, so there much more flexibility in shaping the neck. Different-sized necks may be required depending on the size of the droplet relative to the reservoirs, and other properties of the droplet (e.g., surface tension and viscosity). Accordingly, a TFT architecture often affords the most flexibility in shaping and tuning the neck as compared to typical segmented/direct drive approaches.

The inclusion of polynucleotides or other polymeric materials has been found to usually render the droplets more difficult to cleave from the reservoir. This may be addressed by increasing actuated neck lengths and allowing for longer time intervals to ensure that the droplets have been fully cleaved.

In certain embodiments, there are provided “loading schemes” for instances where droplets may be directly drawn into the microfluidic space, rather than being cleaved from a reservoir. This is a common way of loading various materials onto the pixel array of a microfluidic device and usually requires pulse sequences which differ from those applied to move droplets between locations within the array. The droplets may be pulled into the microfluidic space from the edge of the array or from porting holes in the top plate. If a material is provided in a position physically touching the edge of the array, repeated pulsing of pixels at a location adjacent the edge may be applied to draw droplets over the array. Often, the ability to load a reagent into the microfluidic space is strongly influenced by its chemical composition and some materials require longer pulses and higher voltages. As such, reagent-specific “loading schemes” can be specifically tailored to suit diverse reagent compositions.

According to a further embodiment, there is provided a “merging scheme”, which may implemented for merging together two or more droplets. Included in this type of scheme are one or more drive sequences for moving droplets of different reagents within the microfluidic space as well as merging motion drive sequences for physically combining the droplets together. The merging of different reagents may result in product droplets having different mobility than the original droplets, so the merging scheme may be required to adapt to such changes in mobility. This may be achieved by including drive schemes which are specifically formulated and optimized for the contents of product droplets.

Following the merger of two or more reactant droplets, homogenous distribution of one or more components within the product droplet may be attained by applying the drive sequences of what is hereinafter referred as a “mixing scheme”. The physical mixing of droplets is usually dependent on the reagents contained in the droplets. Variables such as the number of repetitions of the mixing motion pattern, time of mixing, and the elongation of the drops during mixing may be changed to accommodate various reagents. At one easy-to-mix extreme, merging two droplets of the same reagent may require no mixing scheme at all, no additional time for diffusion, and no elongation of the droplets to cause mixing; at the other extreme, two drops containing solutions of distinct, high molecular weight polymers are likely to require repeated execution of the mixing motion pattern, a long mixing time, and multiple elongations of droplets produced by the mixing. For example, the mixing scheme schematically illustrated in FIG. 9 includes two repetitions of a mixing motion pattern whereby a product droplet 90 is subsequently moved to each of the four corners of a square 92 having a diameter approximately twice the length of the droplet diameter.

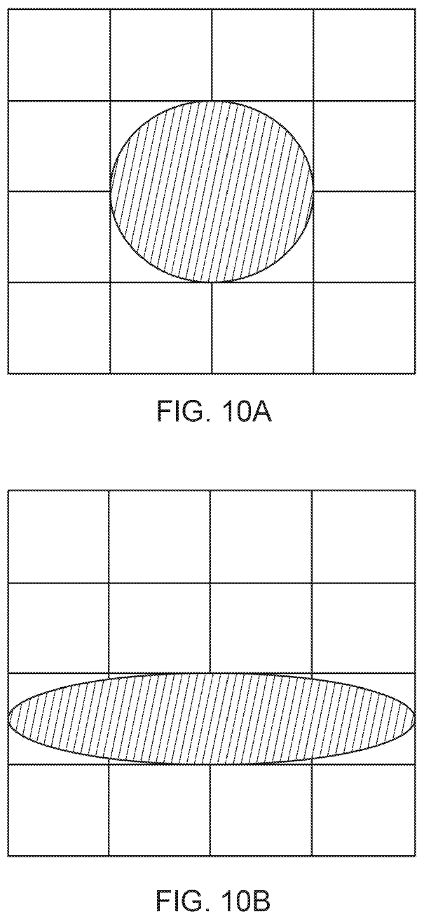

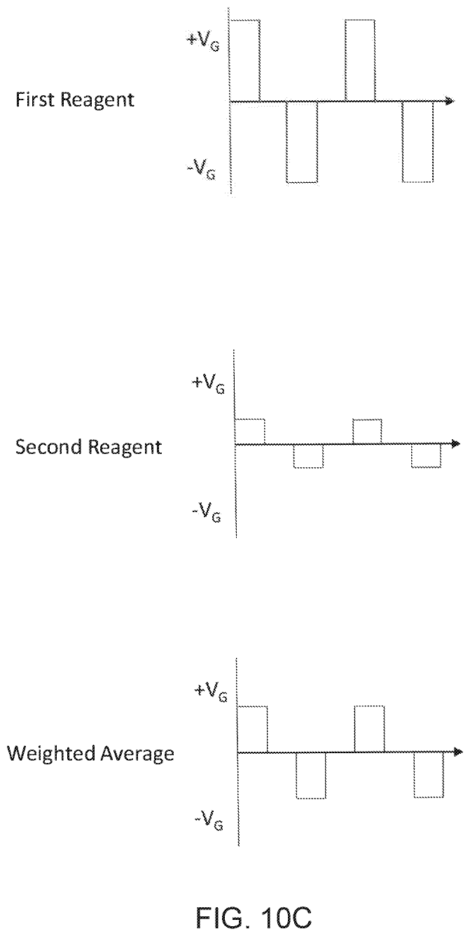

Droplet elongation is usually applicable to droplets having a footprint large enough to cover at least four pixels in the DMF device. In one embodiment, the mixing scheme includes a droplet elongation drive sequence of the type schematically illustrated in FIG. 10. In the initial stage depicted in FIG. 10A, the droplet is symmetric in shape and spread over a 2×2 pixel square. An elongating drive sequence is applied, stretching the droplet to form a linear configuration one pixel wide and four pixels in length (FIG. 10B). A second drive sequence is then applied to restore the original configuration of FIG. 10A, and the process may be repeated until a satisfactory level of mixing is achieved. This approach may be applied to any droplet with a footprint covering a square area n pixels in height and n pixels in length, n being a natural number. The elongating drive sequence stretches the droplet to yield a linear arrangement 1 pixel high and n² pixels long, followed by a second drive sequence restoring the original, symmetric droplet geometry. Here, too, the process may be repeated until the mixing is complete. As anticipated above, the merging of droplets containing different reagents may result in product droplets having different mobility than the original droplets. To facilitate mixing, the mixing drive sequences may be formed by a weighted averaging of drive sequences correlated to the original reagent droplets. In the representative example of FIG. 10C, a droplet of a first reagent is merged with a droplet of a second reagent. It can be seen that the drive sequence optimized for and applied in the instance of the first reagent features pulses of higher voltage than the second reagent. Following merger, this difference is accounted for by applying a mixing sequence formed by a weighted averaging of the first and second sequences. In this instance, the pulses of the third drive sequence are the same in number and frequency as in the first reagent and second reagent drive sequences. However, the pulse voltages applied in the third sequence are weighted averages of the first and second reagent drive sequences, thereby providing a drive scheme better suited to the mixture. In other non-exclusive approaches, weighted averaging may be applied to pulse length and/or frequency, resulting in a mixing sequence differing in pulse length and/or frequency from either or both the first and second sequences.

In an additional embodiment, there is provided a “splitting scheme”, which may implemented for splitting a droplet into two or more droplets. As anticipated above, the term “splitting” is not intended to imply any particular outcome with respect to volume of the resulting droplets (i.e., the volume of the resulting droplets can be the same or different) or number of resulting droplets (the number of resulting droplets may be 2, 3, 4, 5 or more). Included in this type of scheme are one or more drive sequences for elongating a droplet within the microfluidic space to form a neck that is severed to yield two product droplets. The separation of different droplet components may result in product droplets having different contents than the original droplet. Taking as example a droplet containing magnetically responsive beads, the splitting scheme may involve immobilizing the beads at a single place by application of a magnetic field and splitting the droplet to yield a first product droplet containing the beads and a second product droplet free of beads. In instances where a desired product compound is covalently bound or absorbed to the surface of the beads, this process allows for the separation of the compound from other components of the droplet.

In a number of exemplary embodiments, droplets may be held in place and prevented from unwanted drifting by implementing what is hereinafter referred to as a “holding scheme”. As no motion is imparted to the droplets, pulse sequences containing an intermittent single pulse of limited duration are usually sufficient. For a number of solutions containing surfactants a single short negative drive pulse is enough to hold a droplet in place even after the voltage pulse is turned off. The droplet remains held in place until the application of a positive pulse. Often, a single pulse at a potential of about −30 V for a duration of about 200 ms is sufficient for holding droplets that contain surfactants. If the drop is pure water, or water with buffers as may be used in some washing solutions, a constant holding voltage of alternating polarity to avoid device damage from extended DC bias may be required to hold the droplet since a single negative pulse does not often hold this type of droplet in place. The holding voltage may be less than the moving voltage if the controller is capable of applying variable potentials, but could be the same as the movement voltage if that is all that is available in the controller. For each type of reagent droplets, suitable drive sequences may be developed and saved to the look up table.

### EXAMPLES

The following Examples are now given, though by way of illustration only, to show details of particularly preferred methods according to various embodiments of the present invention.

### Example 1

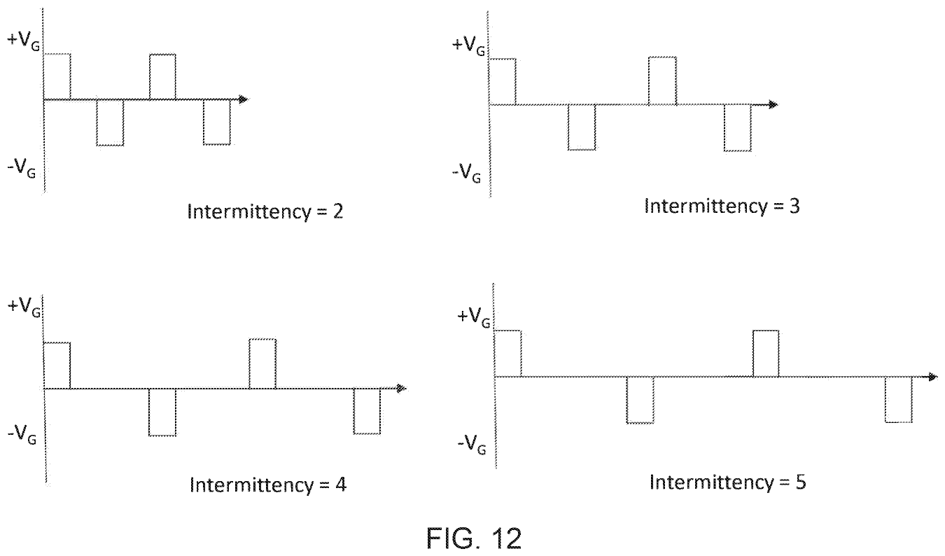

A DMF device surface was prepared by depositing metal oxide dielectric material onto a square TFT array 5.61 inches in length followed by a hydrophobic coating of Teflon AF® (Poly [4,5-difluoro-2,2-bis(trifluoromethyl)-1,3-dioxole-co-tetrafluoroethylene], Sigma-Aldrich Inc., St. Louis, Missouri). A first solution of Tris-HCl 0.01 M in water was prepared and brought to pH 4 by addition of a mineral acid. A second solution was formed by modifying a portion of the first solution through the addition of Tween 20 (Polyoxyethylene (20) sorbitan monolaurate) to a final concentration of 0.05 wt %. Holding schemes were developed and tested on both the first and second solution. Each holding scheme featured intermittent drive sequences where the electrodes under a droplet were first actuated then left idling for the rest of the duration of the hold. As intended herein, the extent of intermittency characterizing a drive sequence is directly proportional to the portion of overall time spent idling. For example, as schematically illustrated in FIG. 12, a driving sequence having an intermittency value of 2 actuates the electrodes for one half of the duration of the hold while a value of 3 applies to driving sequences where the electrodes are actuated for one third of the duration, and so on.

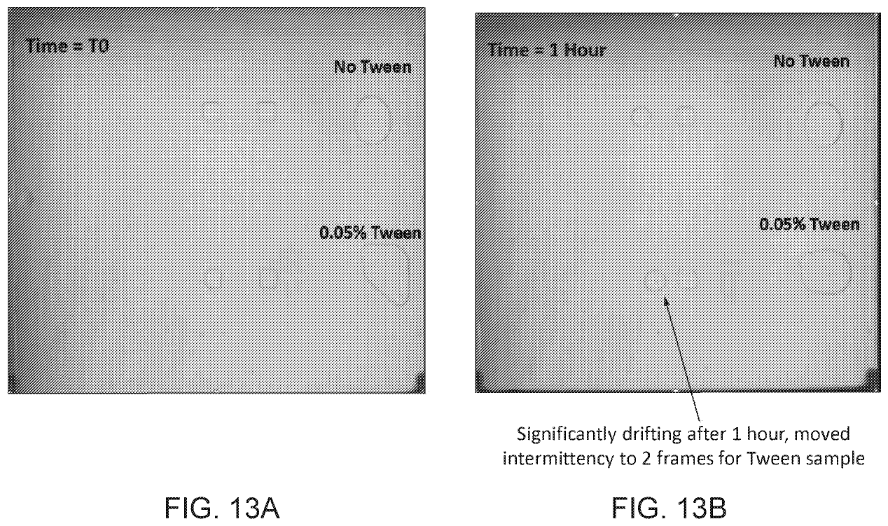

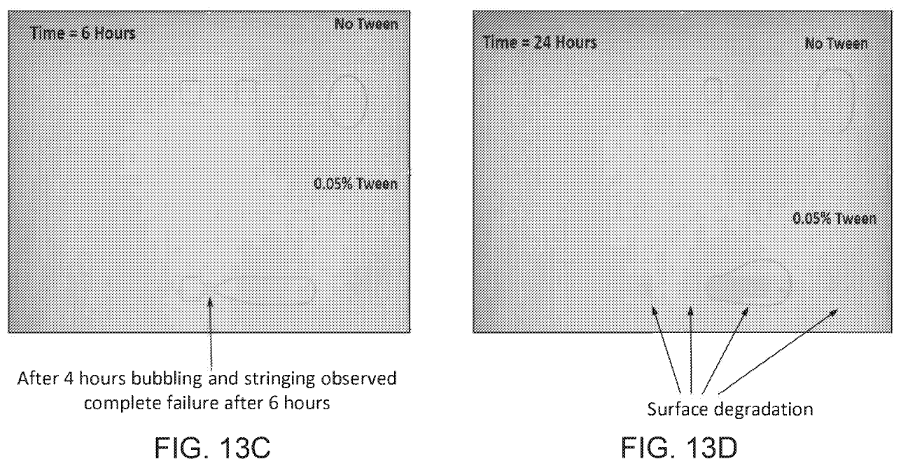

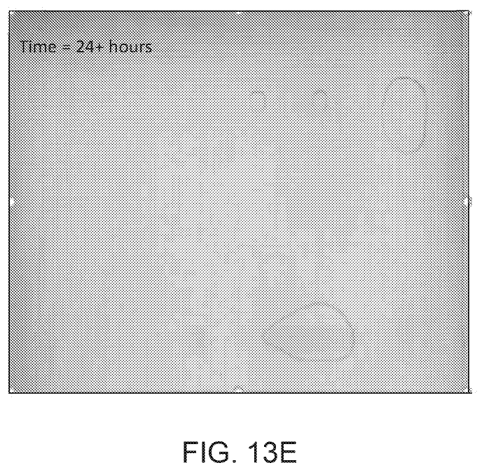

Reservoirs of both the first and second solution were formed in the microfluidic test of the DMF device and tested with holding schemes of increasing intermittency. When applied to the first solution, holding schemes with intermittency values lower than 4 degraded the DMF performance until complete failure invariably occurred within 5 to 6 hours of continuous driving. As depicted in FIGS. 13A-13F, however, when the intermittency value of the holding scheme was increased to 4, improved results were obtained. FIG. 13A is a picture of the DMF shortly after time zero (T0), with the first solution loaded in a first reservoir (“No Tween”) and the second solution in a second reservoir (“0.05% Tween”). Two droplets were dispensed from each reservoir and kept in position by applying a holding scheme having an intermittency value of 4. After 1 hour of operation, as shown in FIG. 13B, the 0.05% Tween droplets began to significantly drift from their assigned positions, indicating a degradation in performance and requiring a drop in intermittency to a value of 2 to restore stability and stop drifting. After about 4 hours, the 0.05% Tween reservoir began bubbling and stringing until complete failure and reservoir drifting was observed at a time of 6 hours (FIG. 13C). After about 24 hours, it was only possible to dispense 1 droplet from the No Tween reservoir, and surface degradation was apparent as dark streaks in areas where the Tween solution was or had been present (FIG. 13D). However, the droplets were very consistent in size and there were no signs of bubbling or increases in hydrophobicity due to surface degradation. Accordingly, in an attempt to determine whether the reservoir was underfilled, the droplet dispense volume was changed to 6×6 pixels, and reservoir resumed dispensing 2 droplets at 24 hours and beyond (FIG. 13E). It can be seen that the No Tween reservoirs is exhibiting no sign of bubbling, stringing, or drifting.

As seen from the results of the aforementioned experiments, drive sequences having an intermittency of at least 4 may enable the manipulation of Tris-buffered droplets for durations of 24 hours or more with no drop in DMF performance. Lower degrees of intermittency, though more efficient in holding droplets in position, appear to cause excessively pronounced degradation and early systemic failure. Increasing intermittency to levels greater than 4, for instance 5, 10, or higher, is likely to lead to even slower performance loss, but at the cost of lower efficacy in limiting droplet drift. In sum, lower intermittency is associated with higher efficacy but faster degradation, and vice versa. As such, a balance may be struck between these two competing requirements by testing drive sequences of different intermittencies on a given composition until a satisfactory regimen is found. Thereafter, the drive sequences may be made part of holding scheme which is part of the drive profile associated with the composition.

### Example 2

A search for drive schemes best suited to dispensing aqueous droplets containing Tween 20 as surfactant was conducted on the DMF array of Example 1. A 0.1 wt % Tween solution in water was deposited into two reservoirs on the edge of the array, then the drive sequences of Table 1 were each tested for dispensing droplets from the reservoirs into the array. The table lists the voltages of pulses applied at each frame in the course of each sequence. As disclosed above, the pulse voltage is the difference in electric potential between the two electrodes associated with a pixel:

TABLE 1

| Drive | |
|---|---|
| Sequence | Frame Sequence (Pulse Voltages) |
| 1 | High, Low, 0, High, Low, 0 . . . |
| 2 | High, Low, High, 0, Low, High, Low, 0 . . . |

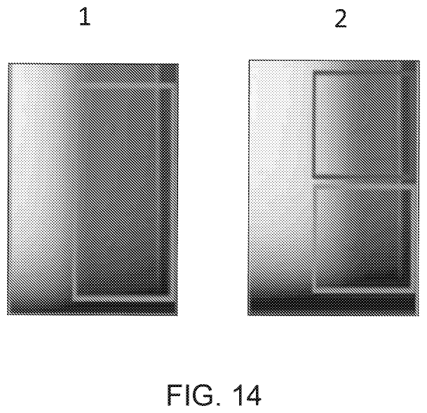

FIG. 14 is a top view of the DMF array after testing of each sequences. Successful dispensing of droplets is framed in green, while failures are framed in red. It can be seen that drive sequence 2 failed to dispense both reservoirs. In contrast, drive sequence 1 successfully dispensed all reservoirs, thereby proving their suitability to Tween 20 aqueous solutions. It is to be understood that the drive sequences are not limited to particular voltage values. For example, the high voltage may be +40V, +35V, +30V, +28V, +27V, +25V, +24V, +22V, +20V, +18V, +16V, or +15V, and the corresponding low voltage may be opposite in sign to the corresponding high voltage, i.e., −40V, −35V, −30V, −28V, −27V, −25V, −24V, −22V, −20V, −18V, −16V, or −15V.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense. The functional aspects of the invention that are implemented on a processing unit, as will be understood from the teachings hereinabove, may be implemented or accomplished using any appropriate implementation environment or programming language, such as C, C++, Cobol, Pascal, Java, Java-Script, HTML, XML, dHTML, assembly or machine code programming, and the like. All of the contents of the aforementioned patents and applications are incorporated by reference herein in their entireties.

In the event of any inconsistency between the content of this application and any of the patents and application incorporated by reference herein, the content of this application shall control to the extent necessary to resolve such inconsistency.

### Example 3

From experiments, it was found that reagents with proteins (with surfactant) do not dispense with the waveform pattern 1, −1, 1, −1. New waveforms were created with different pulse sequences to help dispense. Pulse sequence patterns were found that work well for plasmid (with 0.05% Tween80) in a 0.1% span85 and dodecane system. It was observed that plasmid prefers a positively biased pattern with consecutive positive pulses for dispensing.

### Reagents:

0.05% Tween80 in water
Buffer with 0.05% Tween80
sf-GFP with 0.05% Tween80

### Infill Oil:

0.1% Span85 in Dodecane

### Pulse Sequences

Sequence 1: 0, 0, 0, 0
Sequence 2: 1, −1, 1, −1
Sequence 3: 1, 1, −1, −1
Sequence 4: 1, 1, 1, 1, −1, −1, −1−1
Sequence 5: 1, 1, 1, 0
Sequence 6: −1, −1, −1, 0
Sequence 7: 1, 1, 1, 0, 1, −1, 0
Sequence 8: 1, 1, 1, 1, 0
Sequence 9: 1, 1, 1, 1, 0, 1, −1, 0

Plasmid (with Tween80 as surfactant) was used for 4 reservoirs and Tween80 in water for 1 reservoir and buffer (with Tween80) in another reservoir. Initial tests were performed on a drop size of 7×7 pixels. The voltage was 15V (or −15V).

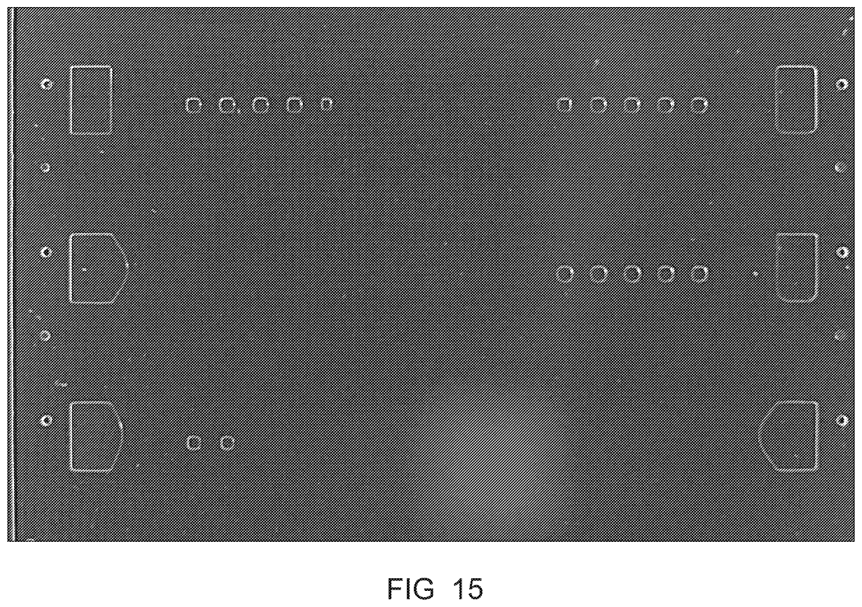

FIG. 15 shows a variety of pulse sequences for different reagents. The balanced pulse sequence (e.g., sequence 2 (1, −1, 1, −1)) dispenses reagents containing a buffer solution (top right and middle right), but does not dispense reagents containing proteins (sf-GFP) (bottom right). Similarly the sf-GFP is not dispensed using the sequence 6 (−1, −1, −1, 0) (middle left). The sf-GFP can be dispensed by pulse sequences having three consecutive 1's, (top left and bottom left). Sequence 5 (1, 1, 1, 0) is better than sequence 7 (1, 1, 1, 0, 1, −1, 0) for this particular reagent composition.

It is seen that plasmid cannot dispense with sequence 2 (1, −1, 1, −1) and neither with sequences 6 (−1, −1, −1, 0) or 7 (1, 1, 1, 0, 1, −1, 0). Buffer dispenses fine and so does Tween80 (in water). Sequence 5 (1, 1, 1, 0) works with plasmid but isn't very reliable. Thus the plasmid/protein sample did not dispense using waveforms that were able to dispense buffer.

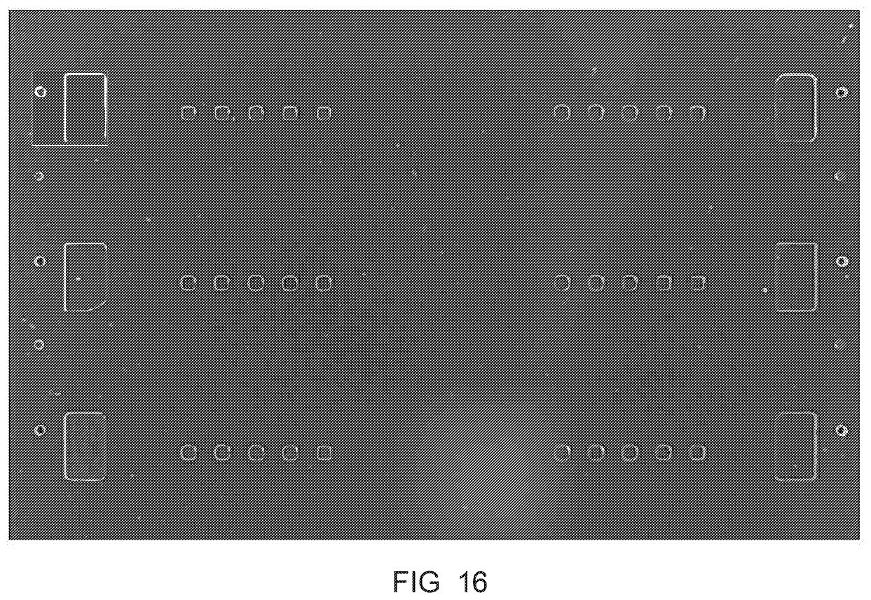

Further pulse sequences were tested, as shown in FIG. 16. Sequences 5, 7, 8 and 9 all dispense the sf GFP plasmid sample for a 7×7 pixel droplet.

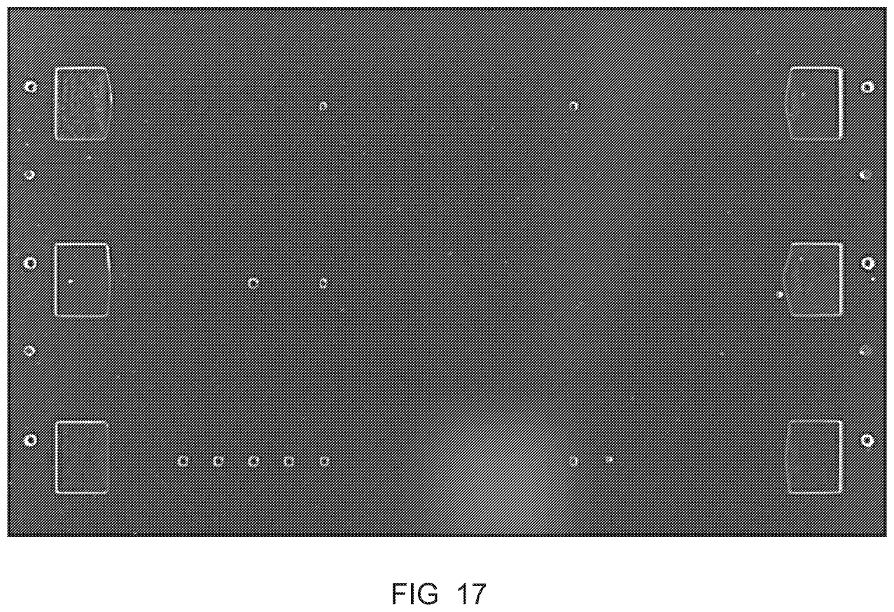

FIG. 17 shows that not all sequences can dispense smaller droplets. Sequence 9, 1, 1, 1, 1, 0, 1, −1, 0 can dispense droplets covering 4×4 pixels (bottom left). Other dispense patterns fail to dispense droplets. FIG. 17 shows that sequence 9 is capable of reliably dispensing droplets of 4×4 pixels. However waveform 9 is unbalanced and likely detrimental to the TFT.

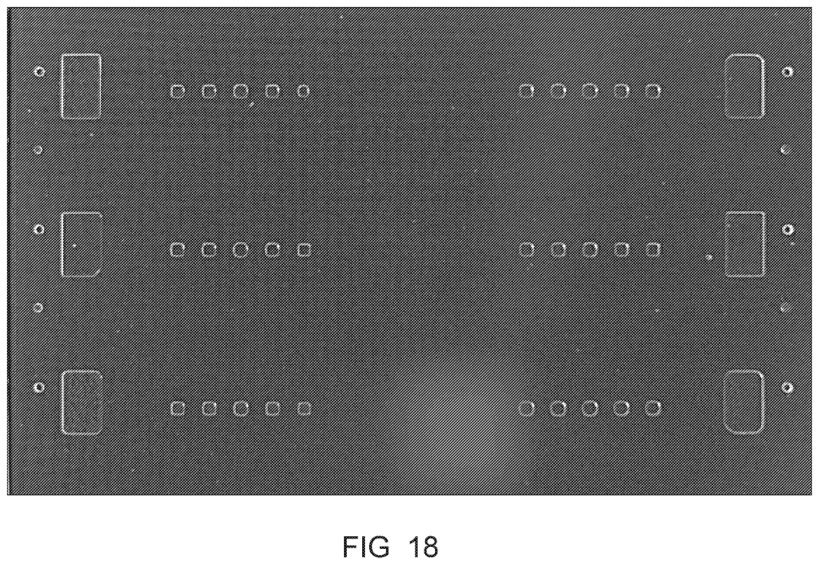

FIG. 18 shows dispensing of SF-GFP with sequences 4, 7, 8 and 9 for a size of 7×7 pixels. For the different positively biased pulse sequences shown, improved reagents dispensing is seen. Since pulse sequences 5, 7, 8 and 9 are unbalanced, long term damage from repeated use is expected. Pulse sequence 4 (bottom left) is balanced (1, 1, 1, 1, −1, −1, −1, −1). Pulse sequence 4 works to dispense, and is balanced.

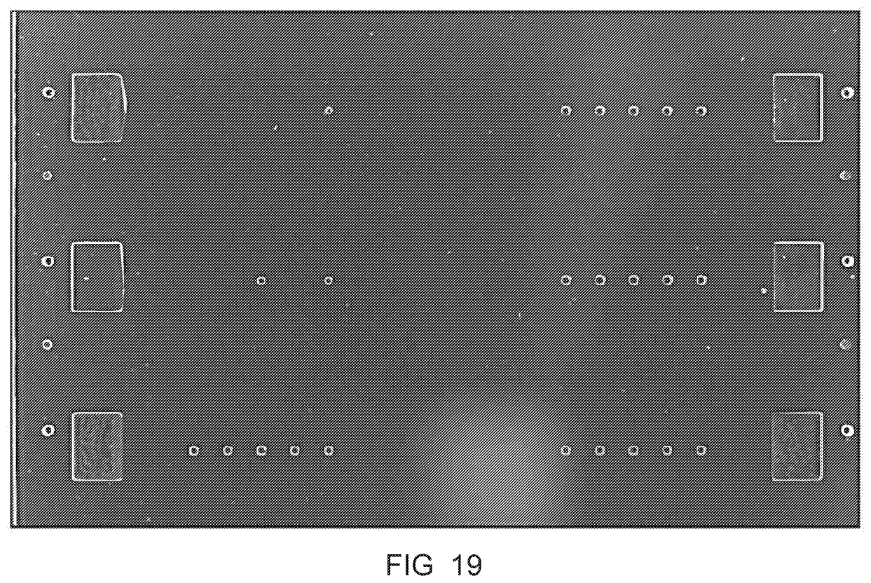

FIG. 19 shows that sequence 4 can dispense droplets over a 4×4 pixel area. Waveform sequence 4 is balanced. Sequence 4, 1, 1, 1, 1, −1, −1, −1, −1 can dispense droplets covering 4×4 pixels. It was observed that for protein reagents, consecutive positive pulse sequences were most effective in dispensing droplets. The balanced sequence 1, 1, 1, 1, −1, −1, −1, −1 causes less charge build up on the array.

It was observed that for plasmid, pulse sequences having consecutive positive pulses were most effective in dispensing droplets. The two sequences that were found to work the best were:
Sequence 9:1, 1, 1, 1, 0, 1, −1, 0 . . . (unbalanced pulse sequence)
Sequence 4:1, 1, 1, 1, −1, −1, −1, −1 . . . (balanced pulse sequence)

Using these two pulse sequences, sf-GFP could dispense droplet size down to 4×4 pixels

### Example 4

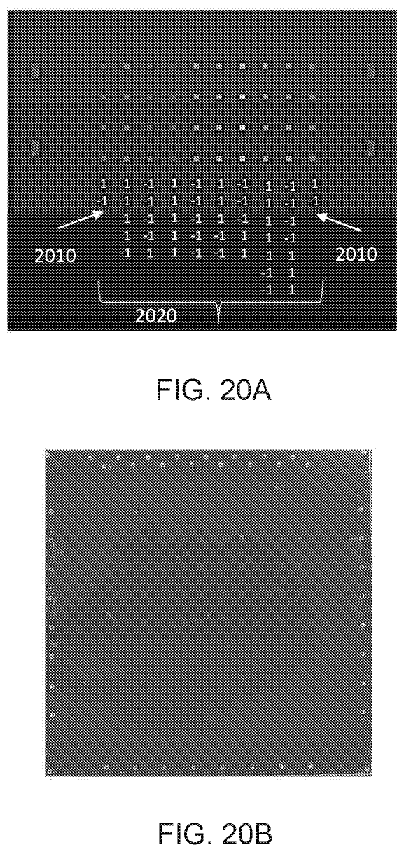

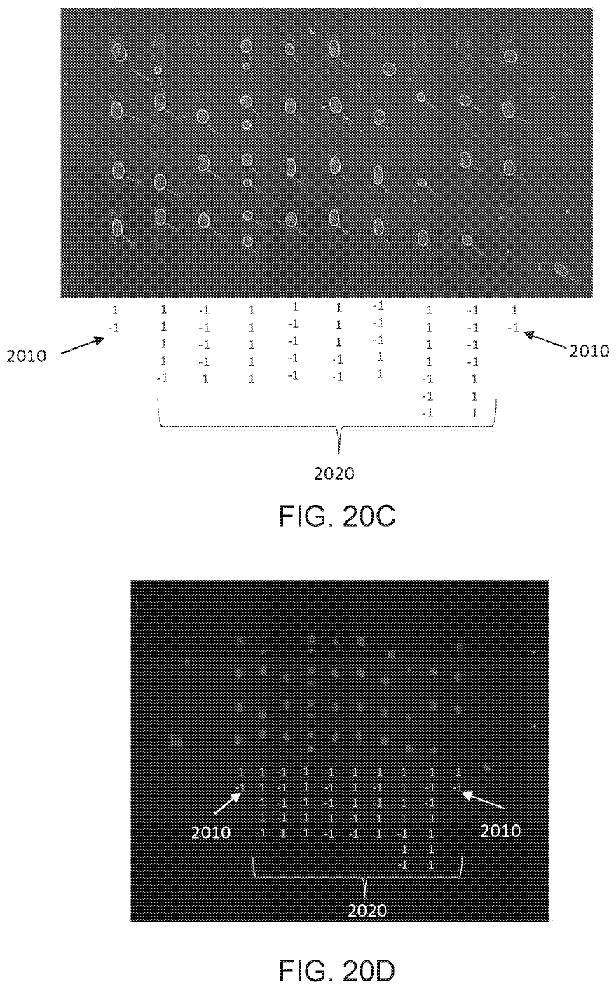

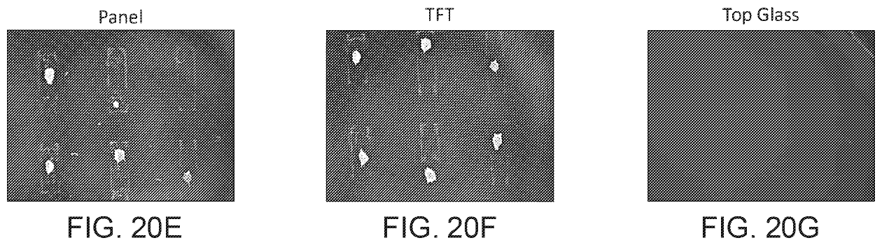

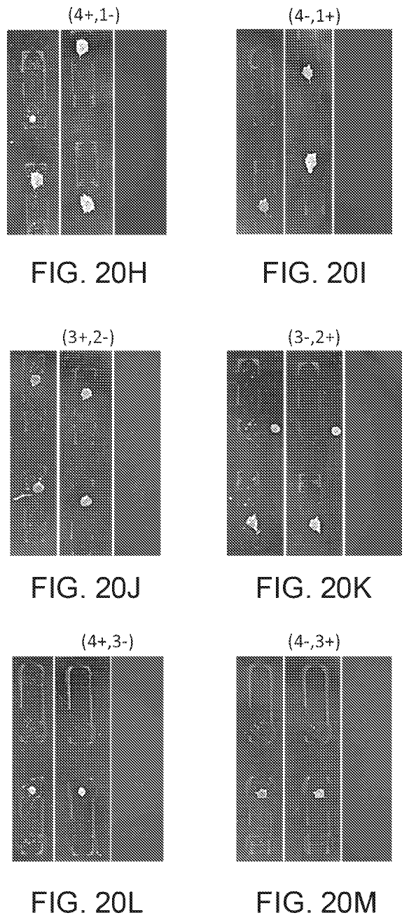

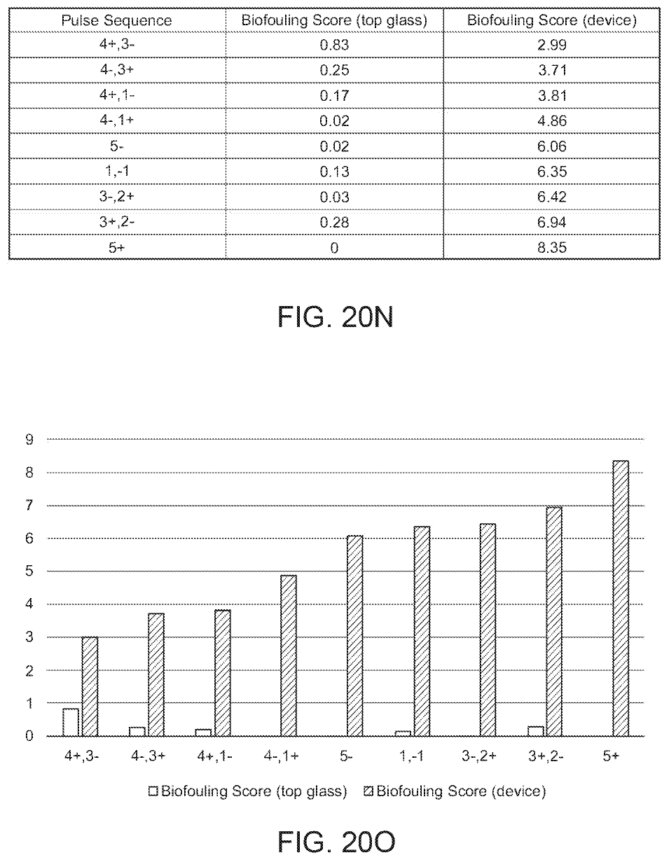

FIGS. 20A-20O illustrate an influence of polarity biases on the degree of biofouling using a variety of pulse sequences, as described below.

FIG. 20A illustrates pulse sequence design and droplet assignment to probe an influence of polarity biases on the degree of biofouling. A series of 8 pulse sequences 2020 can be generated with a polarity bias, alongside 2 instances of (1, −1) 2010 being used as a control sequence (column 1 and 10). The pulse sequences 2010, 2020 used for each column of droplets are illustrated in FIG. 20A. The pulse sequence (1, −1) 2010 can be used in Bin-16 as a default to enable droplet operations like dispense and placement, and may not be used as an incubation sequence. 10 columns of 4 size49 droplets can be dispensed. Each column corresponded to a different pulse sequence 2020 of a different polarity bias. The pulse sequences at C1 and C10 can be (1, −1) 2010 which is the standard pulse sequence used in general droplet operations. The pulse sequences used can be chosen based on a net (1 vs −1) approach, with an excess or 1 or −1 corresponding to a positive or negatively biased pulse sequence. The incubation can be also scripted such that the droplets can be moved upwards by 25 pixels and brought back, such that they can spend half their incubation time in each position. These can be referred to as their “home” and “shuffled” positions. After conclusion of the experiment, the device can be drained, and imaged to record the fouling. The device can be then imaged under a macroscope as the assembled device as well as after the top glass can be opened, to compare biofouling trends between the 2 surfaces.

FIGS. 20B-20D illustrate results obtained by applying the pulse sequences 2010, 2020 shown in FIG. 20A on a device. 40 size-49 droplets can be dispensed, and the droplets can be placed in a 10×4 array using a default pulse sequence (1, −1) 2010 which can proceed without any unexpected issues. After the droplets can be placed in the array, the pulse sequence 2010, 2020 for each column can be changed to a sequence that can incorporate varying levels of charge bias into the pulse sequences for incubation. Pulse sequences 2020 can be limited to 5- or 7-pulses in length so that no excessive charge build up occurs due to truncation of incomplete loops of longer sequences at the end of the 140-frame image. The notation used for these biases are (4+,3−), for example, which can be a shorthand representation of the sequence (1,1,1,1,−1,−1,−1) 2020 containing 4 positive pulses and 3 negative pulses.

When a timelapse series of the droplets can be analyzed, it can show the columns with the most bias (100% positive or 100% negative) can be the first columns of droplets to pin, with the 100% positive bias population being pinning in their home and shuffled positions, while the population with the negative bias can only pin in their home position. The pulse sequences 2020 that can be actuated with reduced droplet pinning were the (4+, 1−), the (4+, 3−), and (4−. 3+) in columns 2, 8, and 9 respectively.

There can be no discernible difference in fluorescence intensities of the droplets, indicating that the expression of protein can be not significantly affected by the polarity bias, which can agree with observations when different pulse sequences can be used in protein expression. The bias, however, can influence the sedimentation/deposition of the protein itself, causing widespread droplet pinning which can be confirmed by the fluorescence images captured. The number of droplets cannot be large enough to cause the formation of a black hole on a panel.

FIGS. 20E-20M illustrate results after disassembling the device shown in FIGS. 20B-20D. Disassembly of the TFT and the top glass can show each surface deposits material, but the protein deposition as well as droplet pinning can occur on the TFT, and salt deposition can be the dominant species deposited on the top glass. The imprint left behind on the TFT may be some CFPS microdroplets/residue that could be a function of the actuation, as it can be restricted to the other boundary of the droplet actuation pattern. 5-pulse repeating sequences in the 140-pulse sequence can show lesser fouling on the top glass compared to the 7-pulse repeating sequences, but the droplets being actuated by the 5-pulse sequences can also show pinning before the 7-pulse sequences. (4−,3+).

FIGS. 20N-20O illustrate biofouling scores for the top glass and the device illustrated in FIGS. 20B-20M when different pulse sequences 2010, 2020 are used. The trends between the salt deposition on the top glass and the total fouling inclusive of droplet pinning can show some divergence. The biofouling score for negatively biased pulse sequences can be lesser than that for the positive bias, or even the default pulse sequence when assessing a score for the salt/mineral deposition on the top glass. With all pulse sequences showing droplet pinning, the biofouling score can be high for all populations, although there can be droplets in the 7-long sequences (4+,3−) as well as (4−,3+) can show the least pinning in 3 out of 8 possible positions. These pulse sequences can be also seen actuating at the end of 24 h during the experiment, which can match the biofouling score to the observations. The biofouling scores for the (4+,1−), the (4+,3−), and (4−,3+) pulse sequences can also match the fact that they cannot completely pin and can be still actuated at the end of the experiment, with the total biofouling score for these 3 sections scoring the least even though there can be some droplet pinning. The trends for droplet pinning and salt deposition seem divergent, and may need additional testing, which can be evident in the case of (5+), with no salt fouling score but the highest total biofouling score. The biofouling score can be exceptionally high for the (5+) sequence due to droplet pinning both positions of all 4 droplets, occupying all 8 possible positions.

As illustrated in FIGS. 20A-20O, the results suggest that the deposition of materials on the top glass can be reduced with negative bias, with the (4−,3+) pulse sequence showing the least deposition. The lowest biofouling of the top glass can happen with the (4−,1+) and (3−,2+) that show comparable biofouling scores. Droplet pinning, on the other hand, can be the least in case of the (4+,1−), the (4+0.3−), and (4−,3+) pulse sequences, which can suggest that a slight positive bias can be used to avoid droplet pinning. Pinning can be also less of a concern when the surfactant is changed to Facade-TFA1, and a combination of approaches can be necessary to combat the overall biofouling.

### Example 5

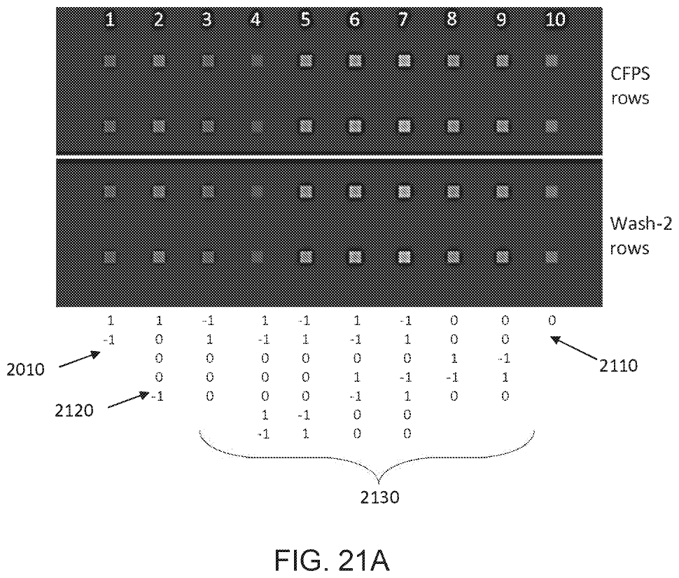

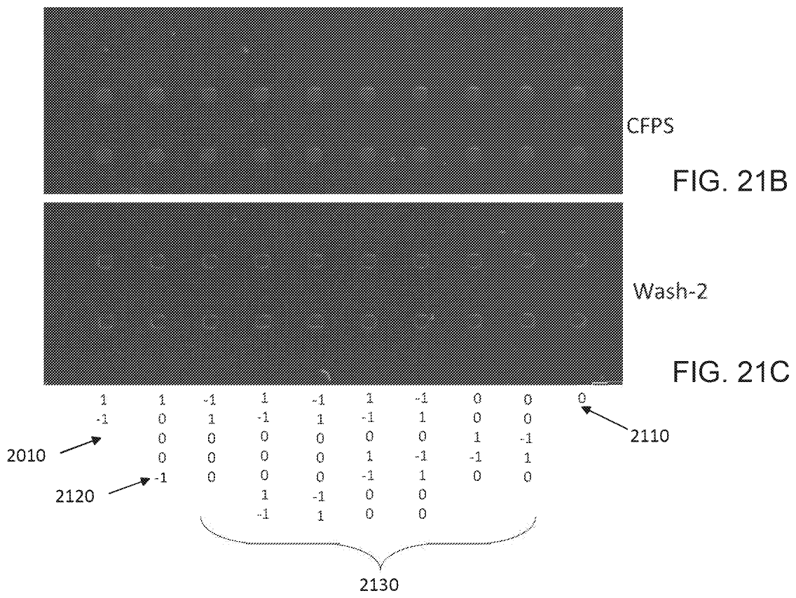

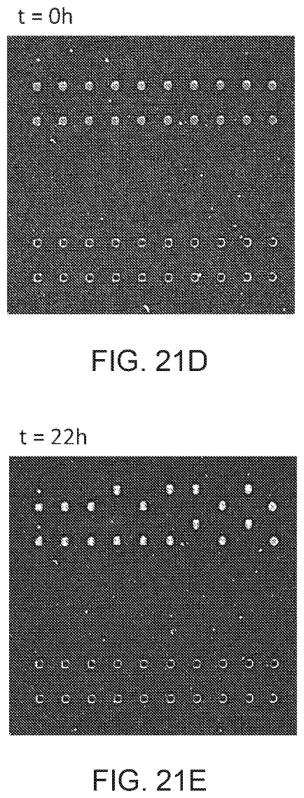

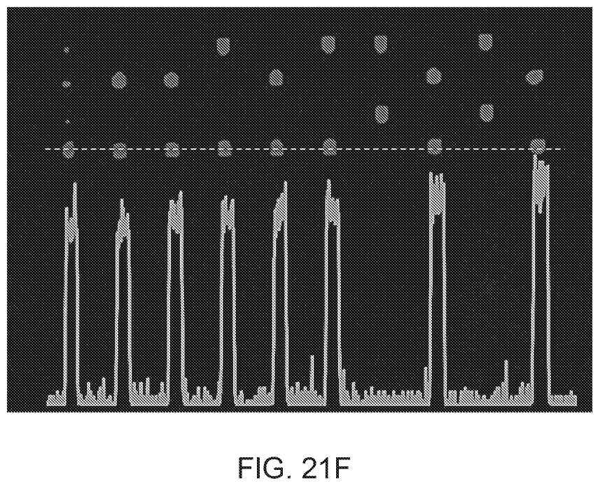

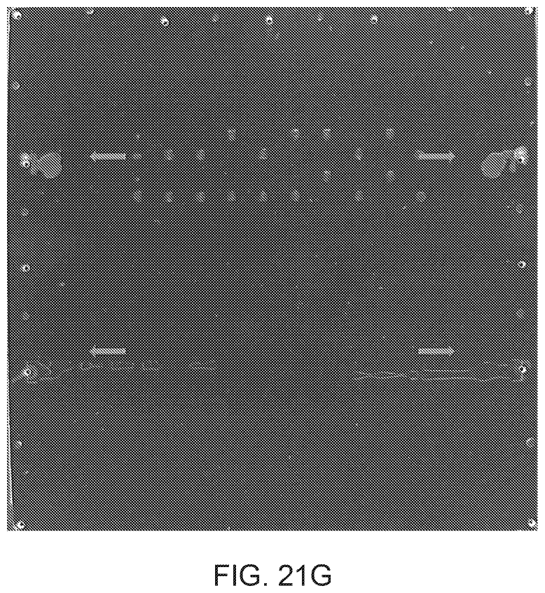

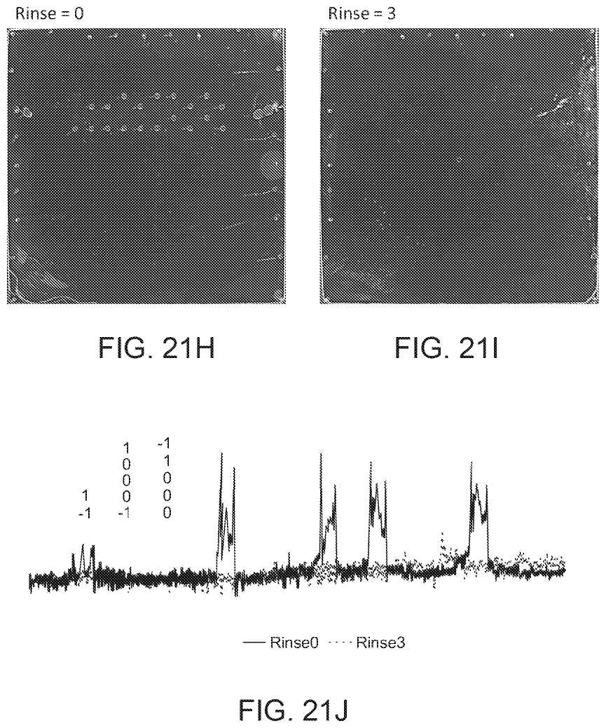

FIGS. 21A-20J illustrate tests on various pulse sequences having relaxation pulses before or after polarity changes, as described below.

FIG. 21A illustrates pulse sequence design and droplet assignment. Relaxation pulses (e.g., [0]ₙ) can be inserted after each polarity change. Each sequence 2120, 2130 can have 3 relaxation pulses. W1 with the pulse sequence 2010 can be used as a positive control, and W10 can be a pulse sequence (0) 2110 used as the negative control and can be left unactuated. W2 can be a pulse sequence (1,0,0,0,−1) 2120. W3-W9 can be candidate pulse sequences 2130 with relaxation pulses after polarity switch with pulse sequences listed in FIG. 21A.

The droplets can be incubated using the pulse sequences 2010, 2110, 2120, 2130 for 24 h. A timelapse image series can be captured every 30 minutes that a panel can be imaged at the same position every alternate frame. Imaging this way can also capture a timelapse series of droplets pinning and their actuation characteristics with respect to the pulse sequence used to incubate/actuate them, and highlight any particular fouling and actuation characteristics. The actuation time can be also split between the 2 positions, and thus time-dependent fouling can be detected based on the residence time of the droplets in those positions respectively.

FIGS. 21B-21C illustrate dispense patterns of CFPS and Wash-2 droplets. The dispense protocol can dispense 10 droplets from each reservoir. CFPS reagents and 10 droplets each of Wash-2 protein-free control can be dispensed. The dispense can appear to be fine and without any significant variations in droplet sizing, and can be comparable between the CFPS and the Wash-2 samples. Pulse sequences used in the incubation stage can be indicated as an overlay onto the dispense pattern.

FIGS. 21D-21F illustrate incubation and protein expression levels after the dispense is carried out illustrated in FIGS. 21B-21C. The expression levels of the droplets can be comparable, although the unactuated droplet can have the highest intensity. This is a trend where the independence of expression vs the pulse sequences can be used, making the use of different pulse sequences for incubation a viable strategy. Also note that the movement of the droplets every 30 minutes can lead to the droplet being pinned in each of its positions, but that behavior cannot be observed in the case of the pulse sequence (1,0,0,0,−1) 2120, where the droplet pins but remains whole. Splitting of the droplet during pinning seems the worst when using the pulse sequence (1,−1) 2010 where each position of the droplet can be a piece of the droplet break off and pin to that position. On the other hand, post experiment actuation can be also best achieved using the pulse sequence (1,−1) 2010 actuated droplets and the other droplets cannot show any movement.

FIG. 21G illustrates withdrawal of droplets back into original reservoirs using the pulse sequence (1,−1) 2010. The Wash-2 rows can be withdrawn successfully into the reservoirs, but only the CFPS droplets applied by the pulse sequence (1,−1) 2010 can show any actuation and movement toward the reservoirs.

FIGS. 21H-21J illustrate protein expression levels after washing the device illustrated in FIGS. 21B-21G. Although washing the device with the wash solution immediately after the incubation step can reduce fouling to a significant degree, the spots that correspond to the use of the pulse sequences (1,0,0,0,−1) 2120 and (−1,1,0,0,0) 2130 can appear lower than the spot actuated by the pulse sequence (1,−1) 2010 although both are comparable. Even with simply draining the device (Rinse=0), the custom sequence (1,0,0,0,−1) 2120 can show less fouling than pulse sequence (1,−1) 2010 and (1,−1,[0]ₙ,1,−1) 2130 which can be designed as pulse sequence (1,−1) 2010 with relaxation pulses introduced in between successive (1,−1) pulses. Longer pulse sequences (e.g., (1,−1,[0]ₙ,1,−1)) can also show droplet pinning that does not get liberated during drainage, which is not a desirable outcome.

The process of immediate device wash can be successful in reducing fouling even in the case using the pulse sequence (1,−1) 2010 which can be pretty heavy if not washed immediately. This can be true even for actuated reagents that do not contain protein, and some of the worst fouling seen can be involving the use of ascorbic acid as an O₂ scavenging molecule to induce hypoxia in the device.

As illustrated in FIGS. 21A-21J, the pulse sequence (1,0,0,0,−1) 2120 can be used in incubation steps compared to the pulse sequences (1,−1) 2010 and (1,−1,[0]ₙ,1,−1) with reduced fouling and comparable movement. Compared to the pulse sequence (1,−1) 2010, the pulse sequences 2130 with relaxation pulses can deposit less fouled material, which can be a good aspect to consider while designing waveforms and pulse sequences.

### Example 6

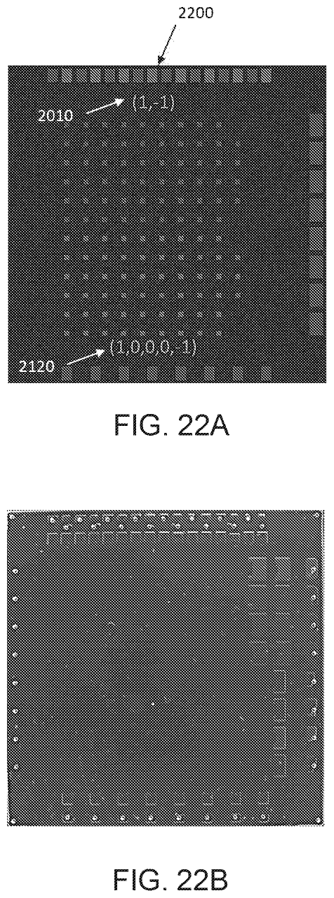

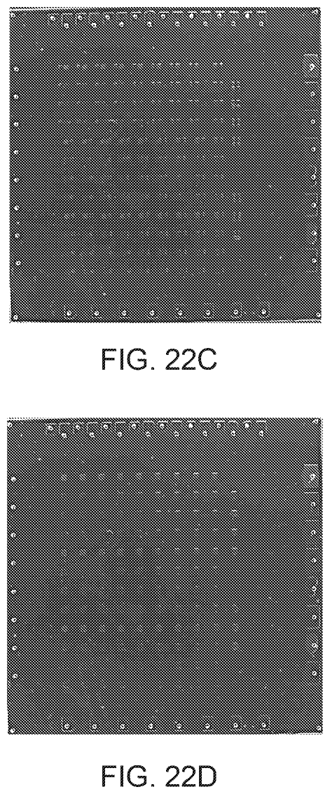

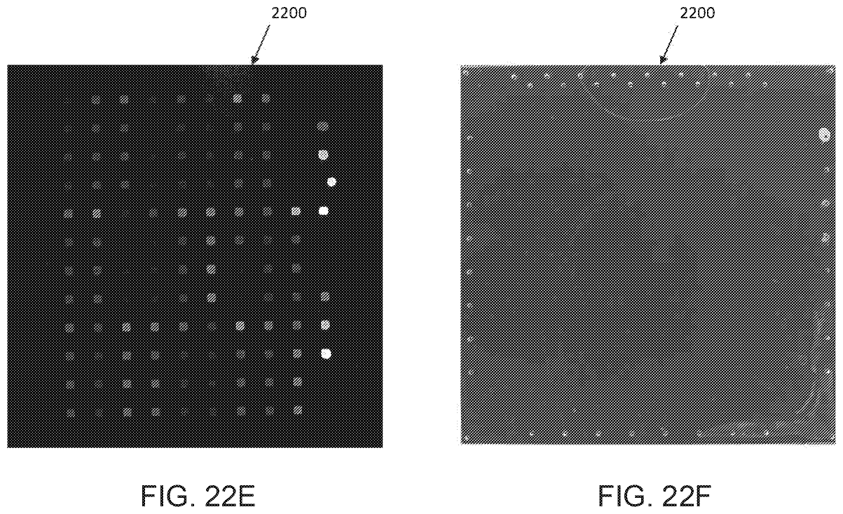

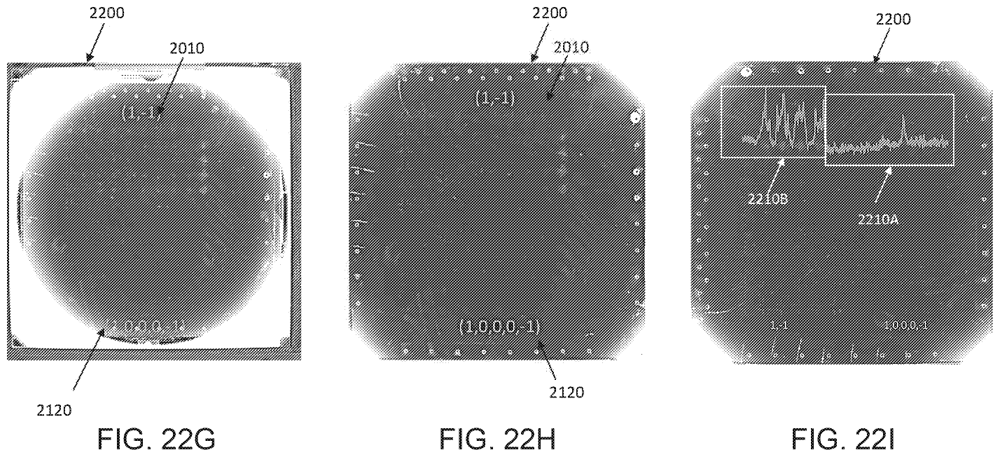

FIGS. 22A-22I illustrate a comparison between the pulse sequences (1, −1) 2010 and (1,0,0,0,−1) 2120 applied on an expression panel 2200 during a biofouling post incubation stage, as described below.

FIG. 22A illustrates pulse sequence design and droplet assignment. The objective of the pulse sequence design and droplet assignment can be used to directly compare the biofouling post incubation stage by running the expression panel 2200. A reagent kit can be used. The kit can be thawed and loaded into reservoirs. The loading sequence can be ALPL 1-8 in A1-8; ALPL 9-12 in B1-4, VEGF 1-4 in B5-8, and VEGF 5-12 in E1-8. The lysates and standards can be loaded in row D. A single channel pipette can be used to load the reagents directly into the porting holes to avoid contamination due to the close placement of the porting holes in the DMF assembly. In some embodiments, a multichannel pipette can be used to load reagents in the reservoirs in rows D and E. The pulse frequency for the drawbridge can be changed from 2 to 1 to have it constantly actuated for easier loading in the assembly.

The expression reaction can be monitored using timelapse software (e.g., Basler timelapse software). A camera (e.g., Basler camera) can have a lower readout and longer exposure time. Exposure times of 500 ms can be used to visualize conventional GFP assay premix (with LS70), but it may not be observed to be sufficient to visualize the low expressors in the expression panel 2200. The experiment can be performed at room temperature. The lysates can be thawed separate from the DNA due to the time delay between loading the DNA reservoirs and lysate reservoirs.

The pulse sequence (1,0,0,0,−1) 2120 can be used in the incubation stage. The lower half of the panel 2200 can be incubated with the pulse sequence (1,0,0,0,−1) 2120 and the upper half can be incubated by the pulse sequence (1,−1) 2010. The incubation phase can be for 24 h. The mixing protocol can be carried out as the droplets are moved in a cruciform pattern. The use of pulse sequence (1,0,0,0,−1) 2120 can necessitate the use of a slower protocol, which can be achieved by the use of Speed=1 and redundancy >2. A redundancy value of 3 can be used in this experiment. At the end of the incubation phase, the pulse sequence can be changed to (1,−1) 2010 and all the droplets can be moved to the porting hole at the corner of Edge 1 and 4 for removal as can be the case in the Clean up phase after the Screen phase. The device can be then drained and checked for biofouling under the Basler camera as well as the macro and microscopes.

FIGS. 22B-22D illustrate loading patterns using different reagents. Loading the reagents onto the device can be relatively easy and uneventful. The device may not be packaged into a cartridge, and to prevent contamination, the reagents can be loaded using a single channel pipette. Loading onto the panel 2200 can be quite straightforward. No reservoirs can be used to be topped up and reservoirs can be formed with minimal handling. Row D reservoirs can have a 2× loading of 6.5 uL, and appear notably overfilled, although that may get automatically corrected in the formation of the mother-daughter reservoirs.

FIG. 22E illustrates an incubation pattern actuated by the pulse sequences (1,−1) 2010 and (1,0,0,0,−1) 2120 for 24 hours. The array can be incubated for 24 h after forming the array and merging the droplets. Half of the panel 2200 can be actuated with the pulse sequence (1,−1) 2010 and the pulse sequence (1,0,0,0,−1) 2120 can be used to actuate the other half. No waveform-dependent suppression of protein expression is expected, with protein expression differing with LEC and bioink combinations.

The combination of Construct 1352+Lysate-121 can yield the most protein at 0.758 mg/mL after the screen run, but correcting for molecular weight, the highest expression can be observed for the combination of Construct 1433+Lys121 at 13.3 uM. This may be affected by the missed dispense of constructs on rows A and B, which can cause void reaction zones and missed protein expression.

FIG. 22F illustrates a post incubation pattern. During the post incubation, all the pulse sequences can be switched to the pulse sequence (1,−1) 2010. All the droplets and reservoirs can be then moved to the porting hole at the corner of Edge 1 and 4 for removal. After 24 h of incubation with the pulse sequence (1,0,0,0,−1) 2120, the droplets can still be actuated and moved towards the porting hole for removal. One aspect that works in favor of this removal is the mixing in the cruciform pattern. This constant movement can prevent pinning of the droplets in a particular position, and can help with the ability of the droplets to be actuated after the experiment. In contrast, static incubation has not previously shown similar levels of movement, hinting that constant movement of droplets can be necessary for them to be actuated after incubation. Some oil can evaporate overnight, but the reservoirs displaced due to this air bubble can be also caught by the actuation and moved to the harvest port during the clean-up protocol.

FIGS. 22G-22H are images captured by the Basler camera of the whole panel 2200. The top half of the panel 2200 can be incubated using the pulse sequence (1,−1) 2010, and the bottom half of the panel 2200 can be actuated using the pulse sequence (1,0,0,0,−1) 2120. The area actuated by the pulse sequence (1,0,0,0,−1) 2120 can show significantly lower biofouling than the area actuated by the pulse sequence (1,−1) 2010. The panel 2200 can be incubated overnight, which can make the pulse sequence (1,0,0,0,−1) 2120 for use in the incubation phase of protein expression. These timelapse images can also illustrate that the pulse sequence (1,0,0,0,−1) 2120 generates enough driving force to keep up with the cruciform pattern. The addition of relaxation pulses in between the 2 voltage applications can make the actuation more sluggish than the pulse sequence (1,−1) 2010, which may reduce the driving force experienced by the droplet, making the corresponding pulse sequence not suitable for large scale droplet movements like serpentine patterns or dispensing. The pulse sequence (1,0,0,0,−1) 2120 can be able to drive the droplets to move in a cruciform mixing pattern, which can be deemed sufficient.

FIG. 22I is a linescan 2210 illustrating biofouling on the panel 2200 over the column of standards. The pulse sequences 2010 and 2120 are noted at the bottom of the image, corresponding to the pulse sequence used to actuate the corresponding half of the panel 2200 as illustrated in FIGS. 22B-22H. The section of the panel 2200 that is actuated with the pulse sequence (1,0,0,0,−1) 2120 has a linescan intensity 2210A closer to the baseline than the section actuated with the pulse sequence (1,−1) 2010 having the linescan 2210B. A duty cycle of 40% (2 actuation pulses and 3 relaxation pulses) may be effective in reducing hypoxia, but the movement of the droplets using these sequences can be sluggish due to the relaxation pulses present. The pulse sequence (1,0,0,0,−1) 2120 can be used as an incubation waveform, albeit with slow mixing and adequate redundancy (R>2) to successfully actuate droplets over small-scale movements.

As illustrated in FIGS. 22A-22I, the pulse sequence (1,0,0,0,−1) 2120 can show remarkably reduced fouling when compared directly to the fouling produced by the pulse sequence (1,−1) 2010 on the expression panel 2200. Slower movement with higher redundancy used with the pulse sequence (1,0,0,0,−1) 2120 can result in the droplets being able to be moved using the pulse sequence (1,0,0,0,−1) 2120 without any observed pinning or formation of satellite droplets.

### Example 7

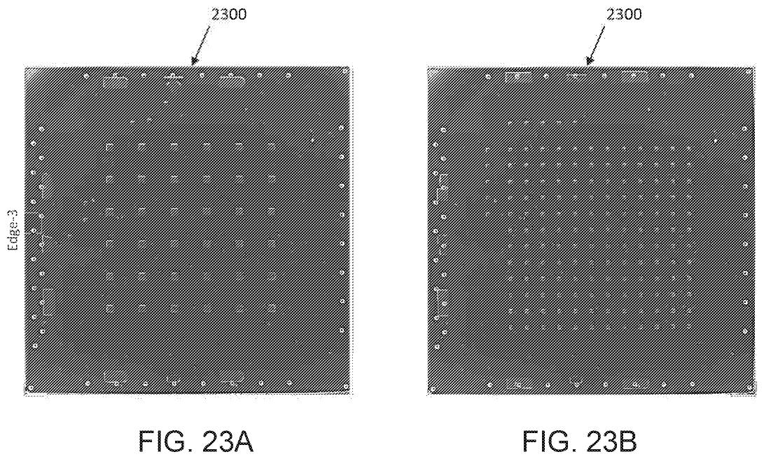

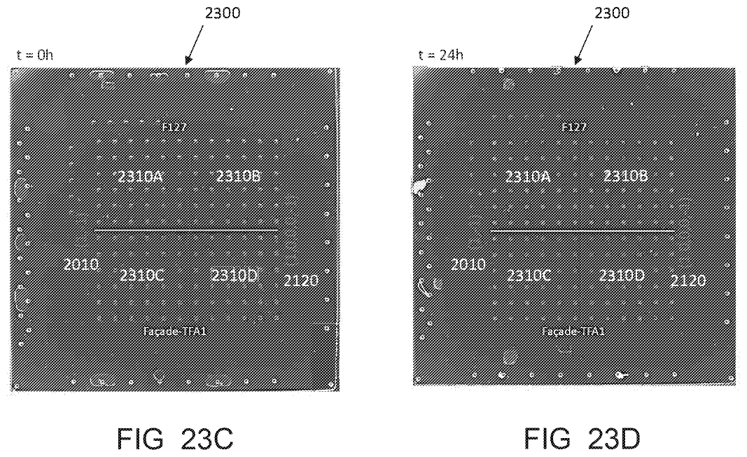

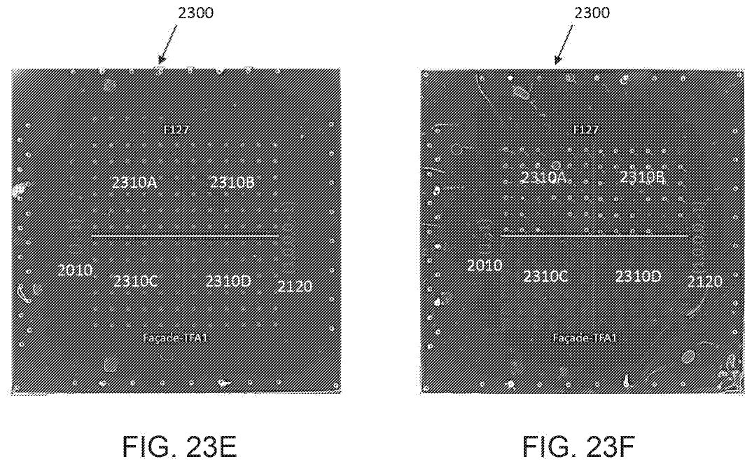

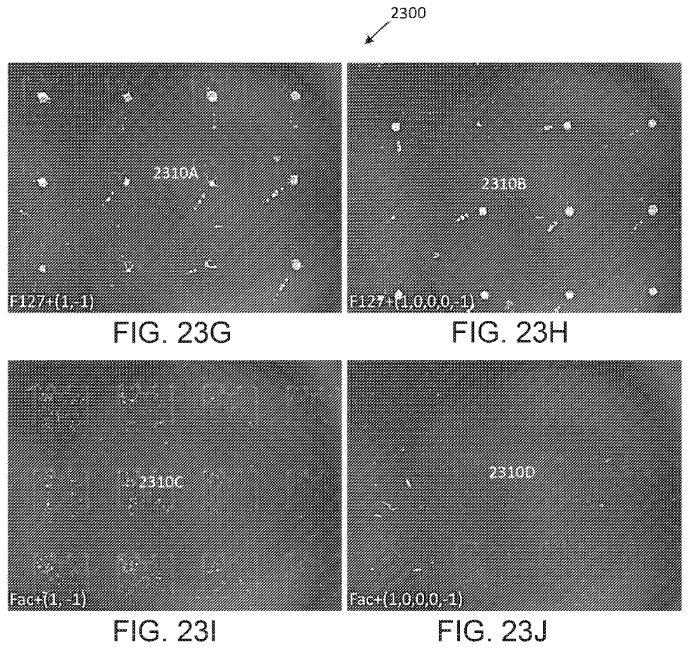

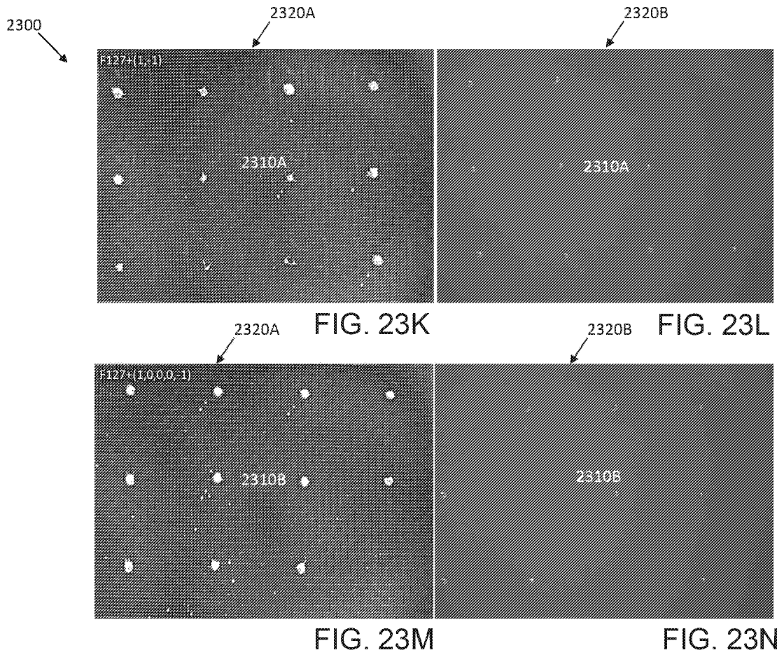

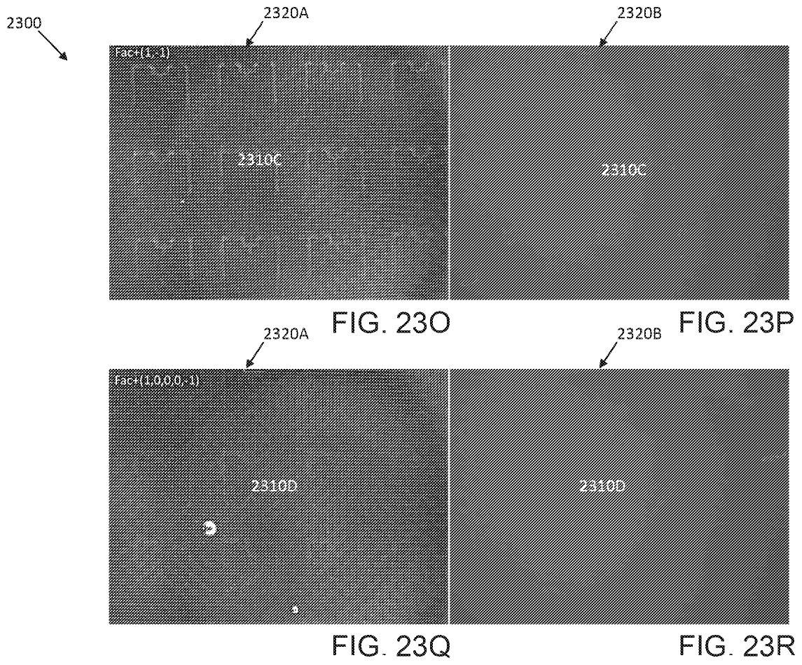

FIGS. 23A-23R illustrate a panel screening using the pulse sequences (1,0,0,0,−1) 2120 and (1, −1) 2010 and using Facade-TFA1 and F 127 as the surfactant phase. Facade-TFA1 has recently come to the fore as a possible replacement of the F127 surfactant system with seemingly promising results. A panel dispensed can be a 12×12 array of size25 droplets, with half the droplets having Facade-TFA1 as a surfactant system and the other half having F127 as a control, as illustrated in FIGS. 23C-23F. Half of each formulation can be incubated with the pulse sequence (1,−1) 2010 and the other half with the pulse sequence (1,0,0,0,−1) 2120, such that the array can be divided into quadrants 2310A-2310D, with each quadrant for a unique surfactant-pulse sequence combination. During the dispense and placement protocols, reagents are not defined, so that the default pulse sequence used can be (1,−1) 2010. Pulse sequences can be changed for the incubation phase.

FIGS. 23A-23B illustrate dispense patterns using the pulse sequence (1,−1) 2010. The droplets cam be dispensed and placed using the pulse sequence (1,−1) 2010. Device performance can be as expected, with no missed dispenses or unexpected hurdles during droplet operations.

FIGS. 23C-23D illustrate dispense patterns using the pulse sequences (1,−1) 2010 and (1,0,0,0,−1) 2120 and using Facade-TFA1 and F 127 as the surfactant phase. Droplets can be dispensed such that each quadrant 2310 can give a unique waveform-surfactant combination, which can make a head-to-head comparison favorable on the same panel 2300. There can be a significant number of pinned droplets on the panel 2300, but interestingly, the droplets having Facade-TFA1 as surfactant cannot show the same amount of pinning as the droplets with F127.

FIGS. 23E-23F illustrate that droplet populations using the pulse sequences (1,−1) 2010 and (1,0,0,0,−1) 2120 and using Facade-TFA1 and F 127 as the surfactant phase after the device is drained. When the device is drained, there can be a clear influence of the surfactant system used in the experiment. Both droplet populations using F127 as surfactant can be pinned to the panel 2300, while the droplets using Facade-TFA1 as the surfactant cannot pin and can be successfully drained with the oil. The biofouling score can be calculated to be the least in the droplets with Facade-TFA1 as the surfactant and actuated by the pulse sequence (1,0,0,0,−1) 2120.

FIGS. 23G-23J illustrate fouling patterns over the 4 quadrants 2310A-2310D of different surfactant-actuation combinations. Images of the panels 2300 can be obtained by the macroscope. The droplets pinned in the F127 quadrants 2310A and 2310B of the panel 2300 can be pinned to the TFT, but the droplet with Facade-TFA1 in quadrants 2310C and 2310D cannot pin and can be drained successfully when filler liquid (e.g., filler oil) is drained. The filler liquid may be a hydrophobic or non-ionic liquid. For example the filler liquid may be decane or dodecane. The filler fluid may be a silicone oil such as dodecamethylpentasiloxane (DMPS). The filler liquid may contain a surfactant, for example a sorbitan ester such as Span 85. All 4 quadrants 2310A-2310D can show varying levels of biofouling, with the Facade-TFA1+(1,0,0,0,−1) in the quadrant 2310D showing the least, and F127+(1,−1) in in the quadrant 2310A showing the most fouling. Between pulse sequences, the pulse sequence (1,−1) 2010 can have consistently shown a greater degree of biofouling than the pulse sequence (1,0,0,0−1) 2120.

FIGS. 23K-23N are images illustrating fouling patterns for TFT 2320A and top glass 2320B using the pulse sequences (1,−1) 2010 and (1,0,0,0−1) 2120 on F127 after the top glass 2320B is opened. The panel section 2310A with the F127+(1,−1) can show droplet pinning on the TFT, 2320A as well as significant deposition of material on the top glass 2320B that can coincide with the locations of the pinned droplets on the TFT 2320A. The top-glass 2320B can be also where material deposition occur in large amounts. This can be observed even for the pulse sequence (1,0,0,0,−1) 2120. Both these panel sections 2310A and 2310B can result in a biofouling score of about 7.

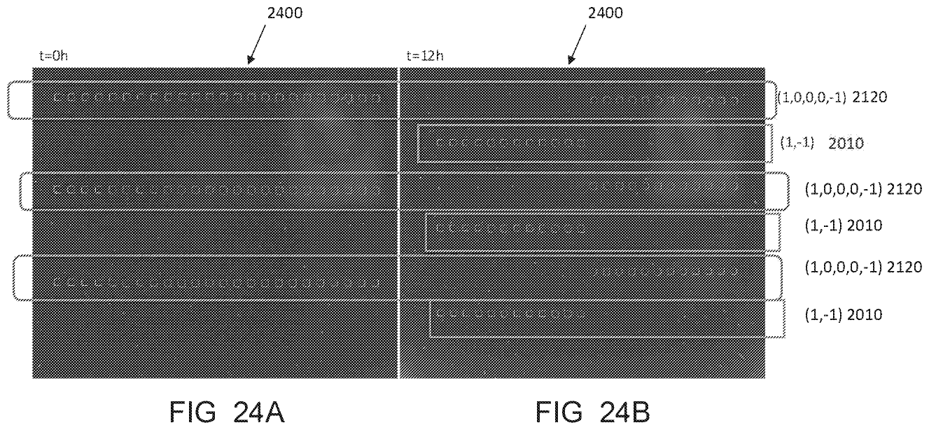

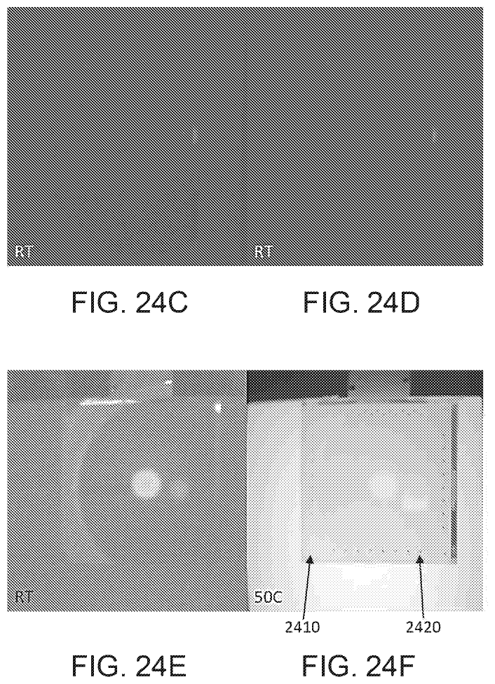

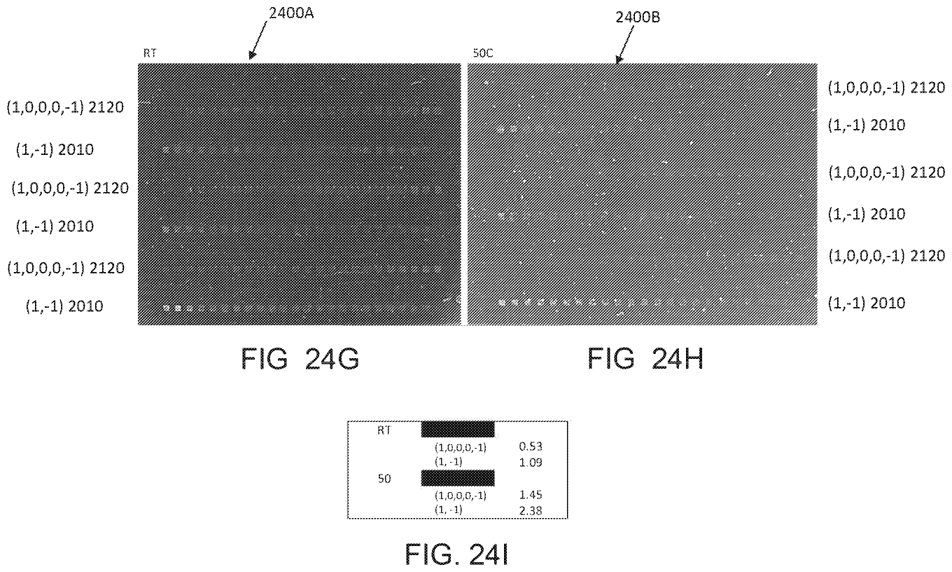

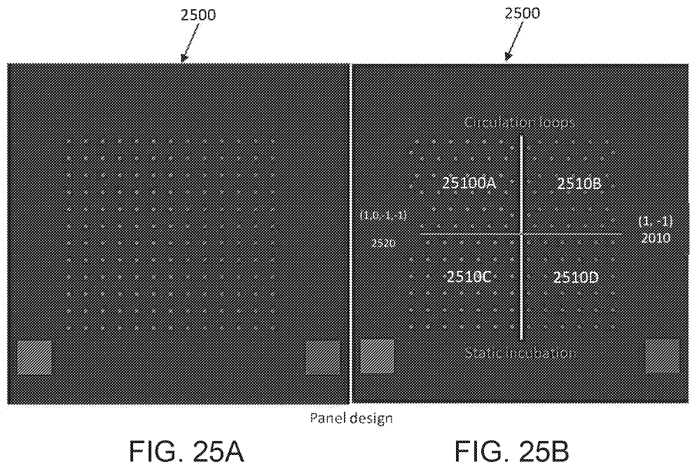

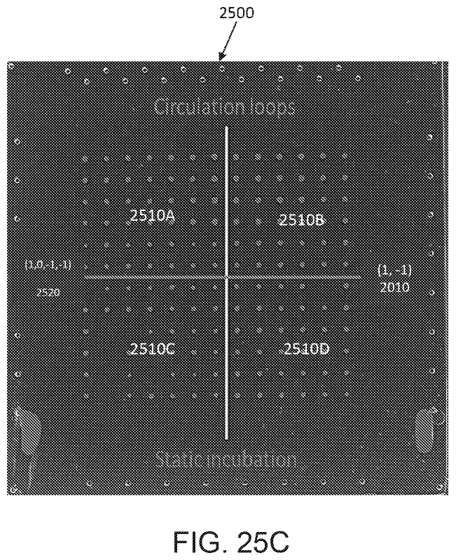

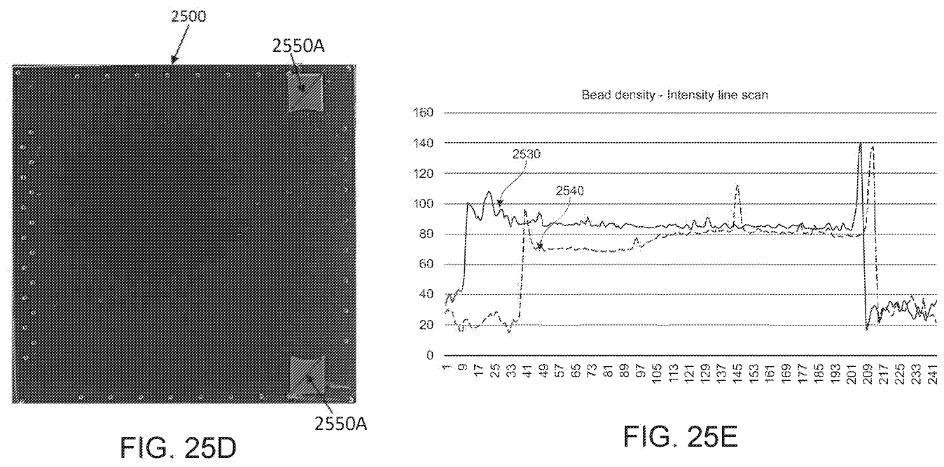

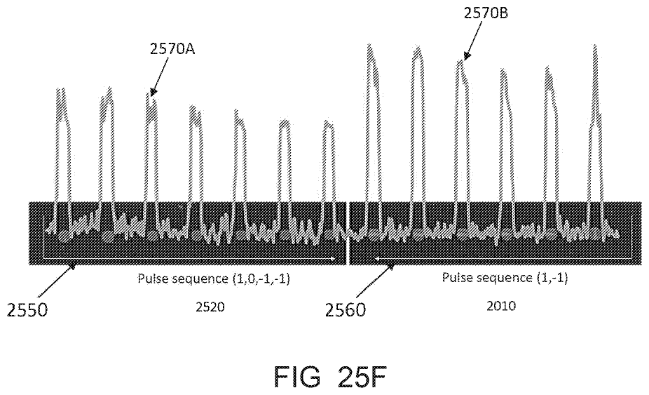

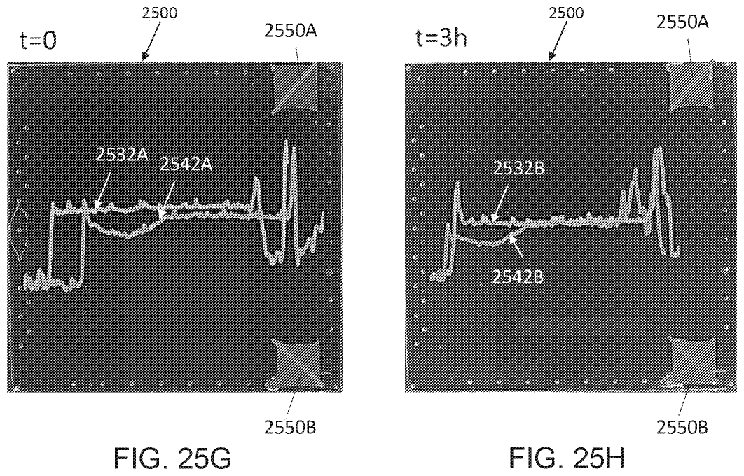

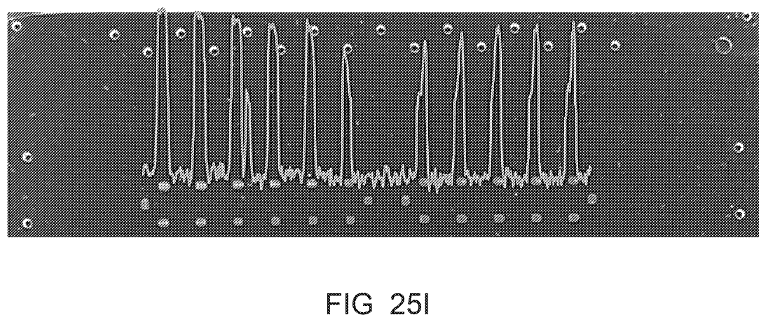

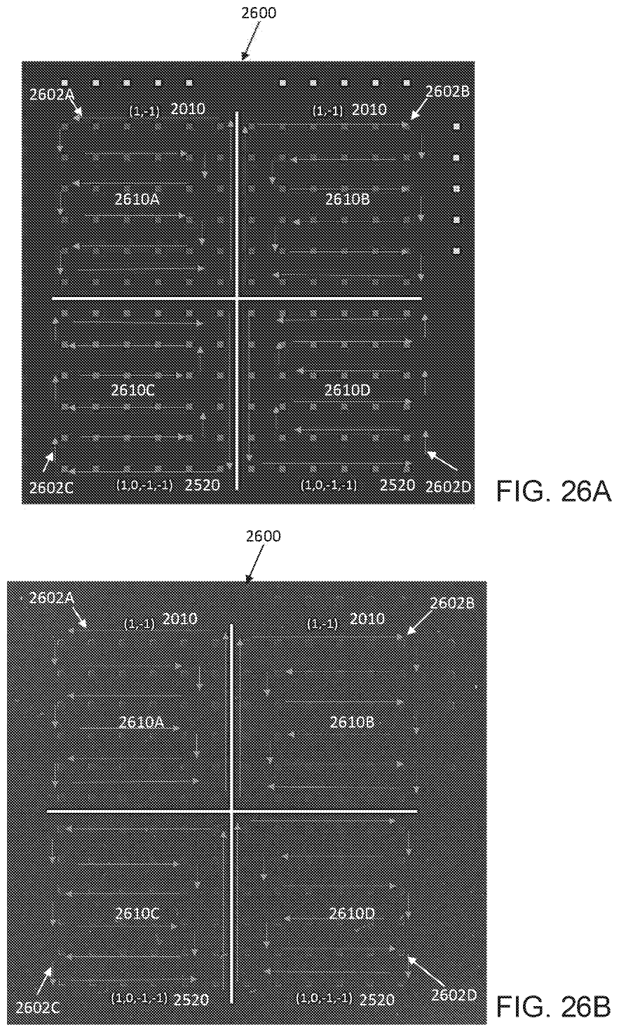

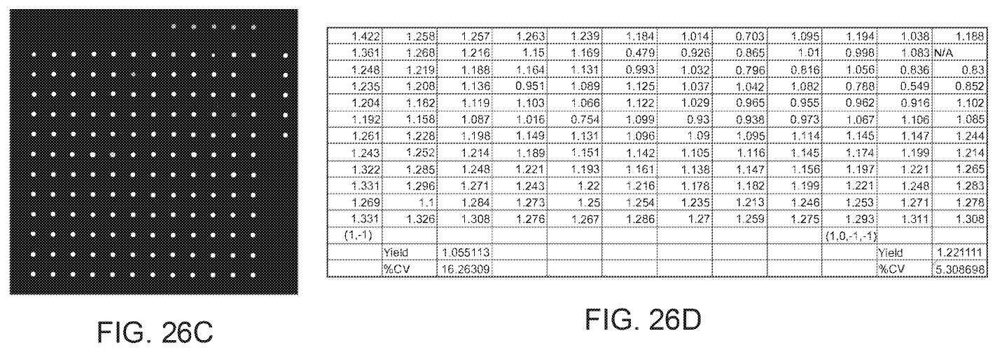

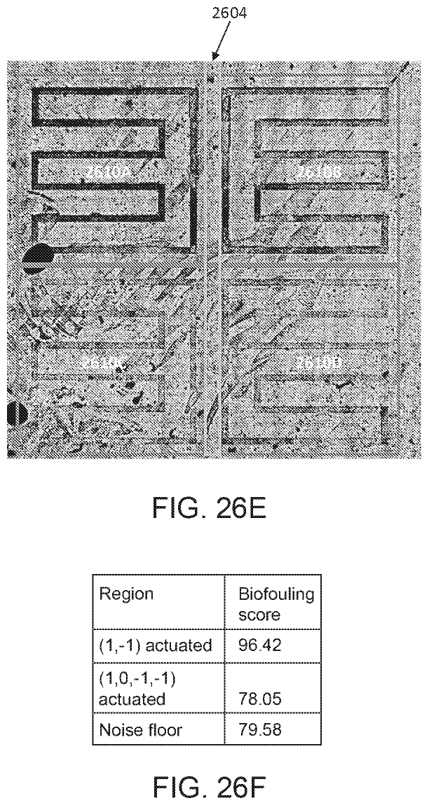

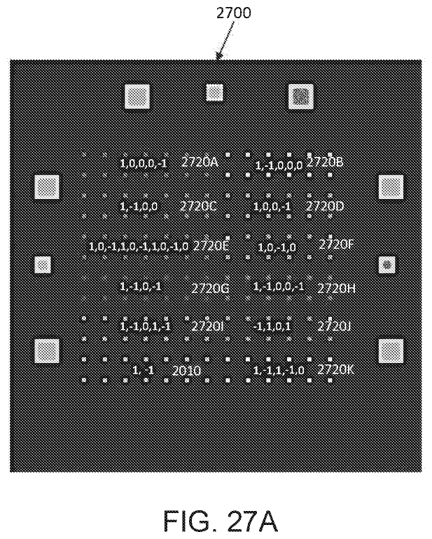

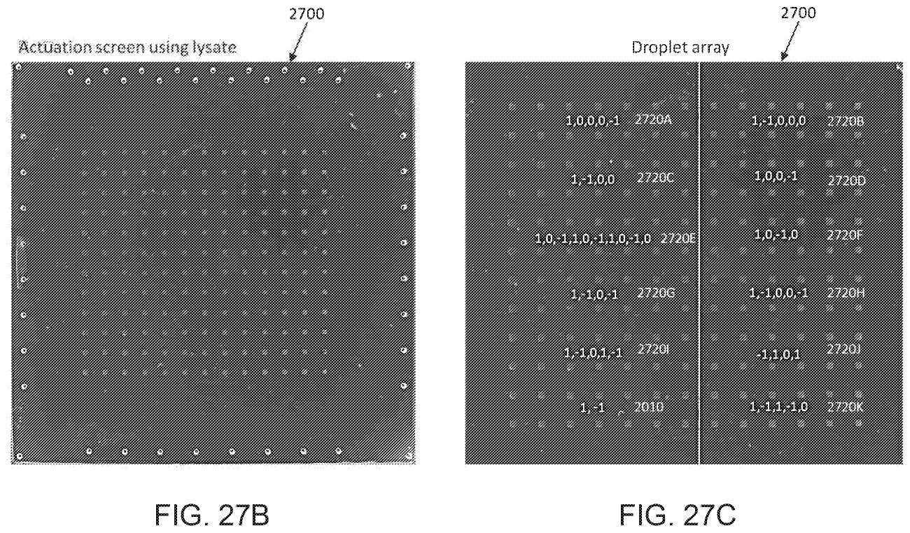

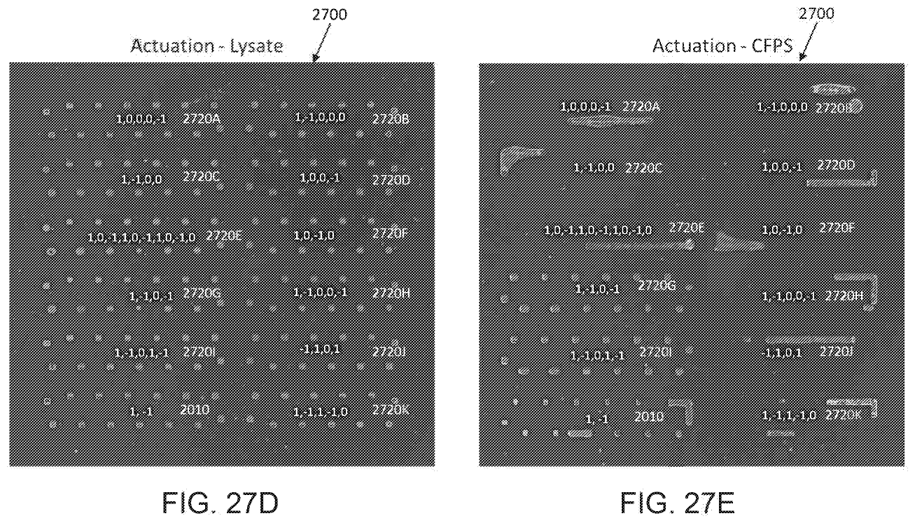

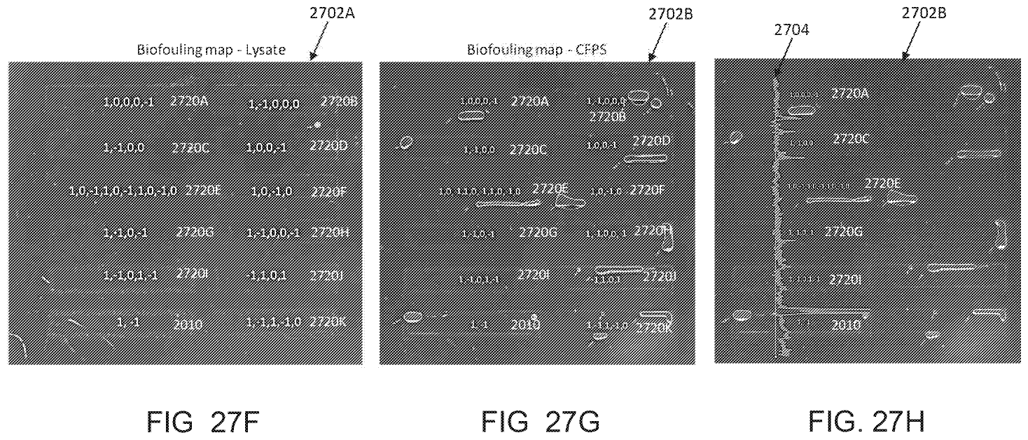

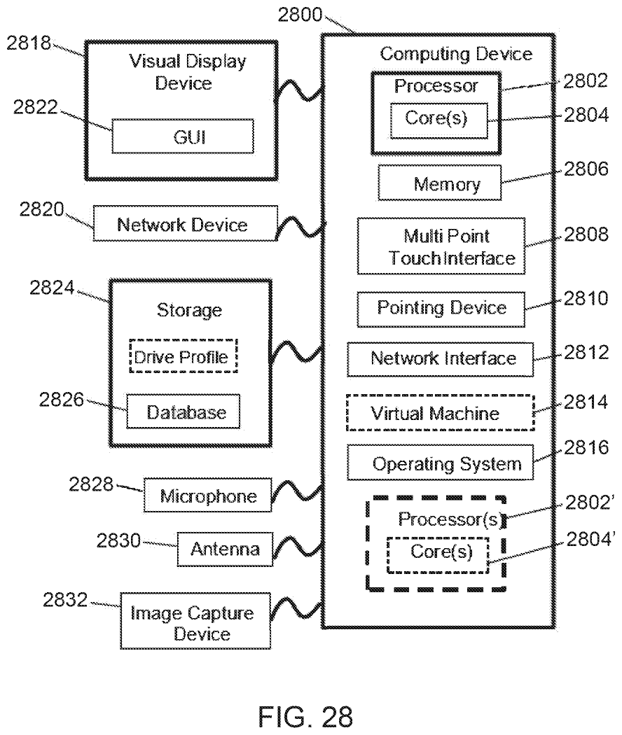

FIGS. 230-23R are images illustrating fouling patterns for the TFT 2320A and the top glass 2320B using pulse sequences (−1, 1) 2010 and (1,0,0,0,−1) 2120 on Facade-TFA1 after the top glass 2320B is opened. The droplets with Facade-TFA1 as the surfactant in the quadrant 2310D do not show any pinning and can be drained along with the filler oil unlike the droplet population with F127 as surfactant as illustrated in FIG. 23M. The biofouling pattern as illustrated can match what is observed in the F127 as illustrated in FIG. 23M, but without the droplet, it can be mainly the deposition of material on the top glass 2320B, along with some fouling in the pattern of droplet actuation. The imprint of the actuation pattern can be seen in all cases of actuation and is comparable across surfactants and pulse sequences, but minimal fouling can be observed on the top glass 2320B in the section 2310D actuated by the pulse sequence (1,0,0,0,−1) 2120. The biofouling score assessed for these populations can be significantly lower than the F127 population, with the pulse sequence (1,−1) 2010 scoring 0.32 and the pulse sequence (1,0,0,0,−1) 2120 scoring a 0.11, which is notably lesser than the pulse sequence (1,−1) 2010.

As illustrated in FIGS. 23A-23R, there can be a clear distinction between the use of Facade-TFA1 coupled with the pulse sequence (1,0,0,0,−1) 2120 which can drastically reduce the amount of fouling as well as can prevent the pinning of droplets to the panel 2300. The biofouling metric can record the least fouling for the Facade-TFA1+(1,0,0,0,−1) droplet population as illustrated in the quadrant 2310D with a biofouling score of 0.11. Material deposition and biofouling can be also observed to be predominantly on the top glass 2320B, while the drop pinning occurred predominantly on the TFT panel 2320A.

### Example 8

FIGS. 24A-24H illustrate device performance of the pulse sequence (1,0,0,0,−1) 2120 used as an incubation pulse sequence at an elevated temperature of 50° C. This experiment can be carried out in 2 variations—one can be at ambient temperature which can be used as a baseline. 36 droplets of size 100 can be dispensed can split once to give 72 size-49 droplets. These droplets can be placed in a 24×3 array. At each 1 h incubation interval, one droplet from the array can be moved into a holding array defined identically to the droplet array, before being moved to a waste reservoir at the end of the experiment. A thermal camera can be used to check for temperature uniformity across the surface of the slide warmer, as well as the average temperature of a panel 2400 vs a surface of a slide warmer 2410 and can determine any temperature gradients that could be generated in this system. After the experiment, the device in the panel 2400 can be drained and imaged under white light to determine the degree of biofouling occurring due to the use of the pulse sequence (1,0,0,0,−1) 2120 over the entire panel 2400.

FIGS. 24A-24B illustrate dispense and placement patterns of the panel 2400 for 0 hour and 12 hours. The dispense and placement of the array can proceed without issues with no missed dispenses and all droplets placed as expected. The droplets can be placed 15px apart, with one droplet being moved from the main/incubation array to the holding/waste position every hour. The holding rows can be actuated with the pulse sequence (1,−1) 2010, while the incubation rows can be actuated with the pulse sequence (1,0,0,0,−1) 2120.

FIGS. 24C-24F are images illustrating a uniform temperature distribution over a surface of a slide warmer 2410 as well as the device 2420 at room temperature (RT) and temperature of 50° C. the device 2420 can be under the surface of the slide warmer 2410. Images can be obtained by a thermal camera. During the temperature ramp, the device 2410 can lag the slide warmer surface 2410 by about 20-30 seconds, but with the average temperature across the area of the device 2420 being equal to the average temperature of a representative area of the slide warmer 2410, suggesting there is no temperature gradient when the slide warmer 2410 is used to apply heat to the device 2420. Use of the slide warmer 2410 to apply high temperature to the device 2420 cannot cause any detectable adverse effects, with all droplets actuated as expected. There can be some evaporation of the filler oil and the reservoirs observed starting on Edge-3, but the evaporation of the liquid cannot reach the section of the TFT with the droplets being actuated.

FIGS. 24G-24H illustrate droplet populations using the pulse sequences (1,0,0,0,−1) 2120 and (1,−1) 2010 at RT and at an elevated temperature of 50° C. In the sample at 50° C. as illustrated in FIG. 24H, there can be lesser fouling seen in the droplet population using the pulse sequence (1,0,0,0,−1) 2120 vs the droplet population using the pulse sequence (1,−1) 2010, although there can be increased fouling throughout. Both panels 2400A and 2400B can be imaged for biofouling under different cameras, which may explain the different visual levels of biofouling. This experiment cannot involve the use of CFPS reagents, and hence there can be no protein aggregation or droplet pinning phenomenon observed.

FIG. 24I illustrates biofouling scores for the droplet populations using the pulse sequences (1,0,0,0,−1) 2120 and (1,−1) 2010 at RT and at an elevated temperature of 50° C. The calculated biofouling scores for the 50° C. droplet populations can be higher than the scores calculated for the RT population. The center of the device can show some enhanced biofouling, but that trend does not appear in the repeated experiment. Comparing the biofouling scores, the pulse sequence (1,0,0,0,−1) 2120 can show a reduction of biofouling by 52% vs the use of the pulse sequence (1,−1) 2010 at RT; and show 60% biofouling vs the pulse sequence (1,−1) at 50° C.

As illustrated in FIGS. 24A-24I, there can be increased fouling of the device at higher temperature, although the pulse sequence (1,0,0,0,−1) 2120 can still show reduced fouling compared to the fouling observed in the case of actuation by the pulse sequence (1,−1) 2010. This can align with observations of actuation using the pulse sequence (1,0,0,0,−1) 2120 causing a lesser degree of biofouling of the device compared to the use of the pulse sequence (1,−1) 2010.

### Example 9

FIGS. 25A-25I illustrate a comparison between the pulse sequence (1,−1) 2010 and a pulse sequence (1,0,−1,−1) 2520 to probe an effect of pulse sequence on the propensity of bead aggregation and sedimentation.

FIGS. 25A-25B illustrate a panel design such that half a panel 2500 being actuated with either waveform can be either incubated in place or can be being moved in a circulatory pattern, giving a unique combination of pulse sequence and incubation pattern in each quadrant 2510. Magnetic bead suspension can be dispensed and placed using the respective pulse sequences (1,−1) 2010 and (1,0,−1,−1) 2520. The magnetic bead suspension can be circulated overnight, to test for any changes to the bead mass with constant actuation. This can be done with constant movement and static incubation, so as to compare between constant movement and no movement to compare strategies to stabilize the beads on the panel 2500 for long periods.

In the second iteration, the same device can be reused without incident. The loaded reservoirs can be incubated for 3 h before beginning the dispense sequence, after which the experiment can proceed without any modifications. Imaging can be carried out every 30 minutes and a timelapse series can be captured for analysis.

FIG. 25C illustrates a dispense pattern using pulse sequences (1,−1) 2010 and (1,0,−1,−1) 2520 on the panel 2500. The dispense of the panel 2500 can show a significant drag, and can result in several missed dispenses and uneven splits toward the end of the dispense sequence. This can result in missing droplets in the array but multiple replicates can provide an idea of the performance of the pulse sequences vs aggregation/settling propensity of the magnetic beads being actuated by each pulse sequence. The dragging of the droplets with magnetic beads can necessitate the optimization of dispense parameters of beads on the device, and can also be tested for compatibility with a sliding split model seen in suitable protocols.

FIGS. 25D-25E illustrate line scans 2530 and 2540 taken through a diagonal dimension 2550 of each reservoir in the left-side panel 2500. The linescan 2530 through the reservoir actuated by the pulse sequence (1,0,−1,−1) 2520 can be relatively flat, indicating a reasonably uniform distribution of magnetic beads in the reservoir. The linescan 2540 through the reservoir actuated by the pulse sequence (1, −1) 2010 can show 2 plateaus, one of which can correspond to the local region with lower intensity which can suggest a localized bead mass compared to the rest of the area of the reservoir.

FIG. 25F illustrates line scans 2570 through the reservoirs for moving droplets. When droplets containing proteins or CFPS mixtures have been moved, striations in the direction of movement can occur. The droplets actuated by the pulse sequence (1,0,−1,−1) 2520 do not show prominent striations for droplet movement in a direction 2550, but in some droplets may show weak striations. In contrast, all of the droplets actuated by pulse sequence (1, −1) 2010 show striations associated with movement in a direction 2560 in the center in this panel 2500.

FIGS. 25G-25H illustrate line scans 2532, 2542 across the panel 2500 where the reservoirs are actuated by pulse sequences (1,0,−1,−1) 2520 and (1,−1) 2010 in place for 0 h and 3 h. The non-uniformity of bead density can be also evident in a subsequent trial where the reservoirs are actuated in place for 3 h before running a dispense protocol. Significant evaporation can be observed, and reservoirs can be topped up with minimal amounts of bead dispersion to maintain the reservoir sizes. The regions for the line scans 2532, 2542 can be chosen to be symmetric around the centerline to capture the same region of magnetic bead settling.

At t=0 hour as well as t=3 hours, there can be observable bead aggregation/settling in the reservoir actuated by the pulse sequence (1,−1) 2010, while there can be no observable settling in the reservoir actuated by the pulse sequence (1,0,−1,−1) 2520. These trends can be further confirmed by line scans running diagonally 2550 through the reservoirs. The presence of a second lower plateau in the population where the pulse sequence (1,−1) 2010 is applied, indicating a region with a higher bead density.

FIG. 25I illustrates a dispense performance of the magnetic beads applied by the pulse sequences (1,0,−1,−1) 2520 and (1,−1) 2010. The dispense performance of the magnetic beads cannot be favorable, with drag being observed while dispensing from both reservoirs, which can be a deviation from the previously observed acceptable dispense performance. The initial droplets dispensed from the side where the pulse sequences (1,0,−1,−1) 2520 is applied can be oversized during dispense and dispensed at a lower apparent bead density. In contrast, due to the settling of magnetic beads near the center of the reservoir actuated by the pulse sequence (1,−1) 2010, the bead density dispensed can appear higher from the reservoir for the pulse sequence (1,−1) 2010 vs the reservoir for the pulse sequence (1,0,−1,−1) 2520. Droplet movement can show striation in the droplets this time which can be present in both populations, and may be caused by other contributing factors in addition to the pulse sequence used to actuate the droplet. The striations can be caused by the microscale flow patterns occurring in moving droplets as an initial hypothesis, and may not be a distinguishing factor for performance of pulse sequences vs bead settling or aggregation.

As illustrated in FIGS. 25A-25I, the pulse sequence (1,0,−1,−1) 2520 can have some potential to be used to incubate or hold reservoirs with magnetic beads because no observable settling can be observed in the reservoir being actuated by the pulse sequence (1,0,−1,−1) 2520 vs the reservoir being actuated with the pulse sequence (1,−1) 2010. Dispense and other droplets can have mixed results between the 2 trials as described herein, with the trial without the initial incubation performing significantly better than the trial where the dispense occur after a 3 h holding period of the reservoirs. Reservoirs actuated by both pulse sequences 2010, 2520 can show significant amounts of drag during dispense and cannot have good performance after holding on the device for 3 h. Dispense testing using a specific panel can be used to optimize the dispense performance after holding the magnetic beads on the device for extended periods. The device can be reused 2× without incident.

### Example 10

FIGS. 26A-26F illustrate feasibility and performance of the pulse sequence (1,0,−1,−1) 2520 when used to actuate CFPS droplets in a serpentine pattern. Often, such continuous movement patterns have caused the maximum observed biofouling, with the added potential for droplets to pin.

FIG. 26A illustrates a layout for pulse sequence design and droplet movements. CFPS premix can be dispensed from two reservoirs and can be placed into a 12×12 array with 25px spacing. Protein standards of 0.5 and 1 mg/mL can be placed along the edges of the array. The array can be split into quadrants 2610 of 6×6 droplets, which can be actuated in their own closed serpentine pattern 2602. The array can be incubated for 24 h with constant movement in the serpentine pattern 2602. Two quadrants 2610A, 2610B can be actuated with the pulse sequence (1,−1) 2010 as the control sequence, and the other half 2610C, 2610D can be actuated with the pulse sequence (1,0,−1,−1) 2520. The experimental setup along with the droplet actuation path in each quadrant 2610 can be shown in the schematic. After 24 h of movement, the device can be imaged under blue light to quantify protein expression. The device can be drained and imaged under white light to determine the extent of biofouling caused due to continuous actuation for 24 hours.

FIG. 26B illustrates droplet distribution dispensed by the pulse sequences (1,0,−1,−1) 2520 and (1,−1) 2010. The dispense of the panel 2600 can occur as expected but with one missed dispense in the panel 2600, but there can be enough replicates on the panel 2600 so that the missing droplet does not have a significant effect on the assay. Droplets being actuated by both pulse sequences 2010, 2520, do not show any pinning, and previous experience agrees with the absence of pinning when Bioink-1 is used. The serpentine movement pattern 2602 can be a particularly rigorous test of actuation reliability with all the droplets moving throughout the experiment over the entire panel 2600, and thus functions as an effective test for actuation reliability.

FIGS. 26C-26D illustrate expression levels caused by the pulse sequences (1,0,−1,−1) 2520 and (1,−1) 2010. The reaction zones being actuated by the pulse sequence (1,−1) 2010 can show a lower average expression and a higher coefficient of variation (% CV) compared to the section being actuated by the pulse sequence (1,0,−1,−1) 2520. Historic data can indicate that pulse sequences cannot be generally correlated with yield. The lower expression can be due to the presence of O₂ consuming reservoirs as well as general historic agreement on hypoxia maps. The missing droplet in the region 2610A, 2610B actuated by the pulse sequence (1,−1) 2010 can also pull down the average yield, but the % CV being around 15 can agree with historic data when hypoxia mitigation via serpentine droplets is used. Yields and CV on both sides can be as expected for an expression system, although the bottom half 2610C, 2610D of the device shows a better CV (at 5.3%) than historically seen.

FIG. 26E is an binary thresholded image 2604 illustrating salt deposition/biofouling pattern when the pulse sequences (1,−1) 2010 and (1,0,−1,−1) 2520 are applied. FIG. 26F is a table illustrating a biofouling score for the pulse sequences (1,−1) 2010 and (1,0,−1,−1) 2520, and noise floor. In this binary thresholded image 2604, the difference between the salt deposition/biofouling occurring in the section of TFT being actuated by the pulse sequence (1,−1) 2010 vs the pulse sequence (1,0,−1,−1) 2520 is quite stark. The section 2610A, 2610B actuated by the pulse sequence (1,−1) 2010 can score 96.4 for biofouling, with the section 2610C, 2610D actuated by the pulse sequence (1,0,−1,−1) 2520 scoring 78. The noise floor can be calculated as 79, implying the pulse sequence (1,0,−1,−1) 2520 can be closer to the noise floor and significantly less fouled than the section 2610A, 2610B of the pulse sequence (1,−1) 2010. The negative bias present in the waveforms/pulse sequences 2010, b may reduce the salt deposition from solution, or suspected ITO corrosion from the top plate, with both the pulse sequences (1,0,−1,−1) 2520 and (1,0,0,0,−1) 2010 showing significant reductions in salt deposition on the top plate. The suitability of the pulse sequence (1,0,−1,−1) 2520 for continuous large scale movement with reduced biofouling can be an encouraging sign to validate that the pulse sequence (1,0,−1,−1) 2520 can be used for an alternate actuation waveform.

As illustrated in FIGS. 26A-26F, the protein yield in the half 2610C, 2610D of the device applied by the pulse sequence (1,0,−1,−1) 2520 can be higher than the protein yield in the half 2610A. 2610B of the device applied by the pulse sequence (1, −1) 2010, but there is no observed correlation between pulse sequence and protein yield by past data. The biofouling score of the pulse sequence (1,0,−1,−1) 2520 can be close to the noise floor while the pulse sequence (1, −1) 2010 can be significantly higher, indicating the pulse sequence (1,0,−1,−1) 2520 can be a viable candidate for a non-fouling waveform.

### Example 11

FIGS. 27A-27H illustrate a screen for a set of pulse sequences 2720 for capability to actuate and move droplets successfully in a manner comparable to the pulse sequence (1,−1) 2010 while also causing a lesser degree of biofouling on the device than the pulse sequence (1,−1) 2010.

FIG. 27A illustrates a layout for pulse sequence design and droplet assignments. Each circulation pattern can be defined with a different reagent pulse sequence 2010, 2720, which can enable the use of 12 pulse sequences 2010, 2720 on a single panel 2700. The pulse sequences 2720 can be designed such that the actuation time of the sequence can increase from 40% in the case of the pulse sequence (1,0,0,0,−1) 2120 to 100% (1,−1) 2010. Actuation percentage can be used as the number of actuation pulses vs the length of the sequence.

The pulse sequence (1,−1) 2010 can be used in Bin-16 so that droplets with no reagent definitions can default to Bin-16, and hence can be actuated by the pulse sequence (1,−1) 2010. This can be potentially a way to change actuation pulse sequences without loading an entirely new waveform into a signal/image processing software. The default sequence can be useful in executing the dispense and split operations that lead the droplets to their positions for the sequence-specific movement screen.

Images can be captured every 30 minutes for 24 hours and droplets can be checked for pinning and collisions. After 24 hours, the device can be drained and images can be captured to check for biofouling that can result from each pulse sequence in the waveform. Reagent R6 can be actuated by the pulse sequence (1,−1) 2010 as the control sequence. The pulse sequence (1,−1) 2010 can be also in Bin-16 which can be used as a default in the case of droplets with undefined reagent bins. This can be leveraged so that the same waveform can be used for the dispense (w/o defining reagents) and the actuation screen (after reagent definition). This actuation screen can be designed to compare the biofouling resulting from continuous actuation of droplets for 24 hours.

FIG. 27B illustrates an actuation screen using lysate. FIG. 27C illustrates a droplet array where the set of pulse sequences 2010, 2720 are applied. Loading and dispense of the panel 2700 can be uneventful when the lysate is used. There can be 3 missing droplets in the experiment with the CFPS premix due to a bad split. The droplets dispensed from the reservoir can locate at a predetermined location, before being split twice to form a 156-droplet array spaced 25px apart. These droplets can be actuated in a circulating pattern, with each circulatory path being actuated by a different pulse sequence.

FIG. 27D illustrates lysate droplets actuated by the set of pulse sequences 2010, 2720. After 18 hours of actuation, the lysate droplets cannot show any pinning and can be continuously moved throughout the duration of the experiment for all the pulse sequences being tested.

FIG. 27E illustrates CFPS droplets actuated by the set of pulse sequences 2010, 2720. Actuation of the CFPS premix can result in the pinning of most droplets. After an 18-hour actuation period, the droplets being actuated by the pulse sequence (1,−1,0,1,−1) 2720I and (1,−1,0,−1) 2720G can be successfully moved in the circulation pattern whereas all other droplets have coalesced after crashing into a pinned droplets in their paths. The synthesis of the protein in the premix can change the viscosity of the droplets, along with some probable adhesion to the device that can cause restriction of movement. The lack of pinning of the negative control vs the pinning can be seen on the premix/positive control at extended periods of actuation. Notably, the pinning seems to progress from least actuated to most actuated, with the droplets being actuated at 40, 50, and 60% duty cycles pinning earlier than the droplet sets actuated with longer duty cycles.

FIG. 27F illustrates a biofouling map 2702A for lysate actuated by the set of pulse sequences 2010, 2720. FIG. 27G illustrates a biofouling map 2702B for CFPS actuated by the set of pulse sequences 2010, 2720. FIG. 27H illustrates line scans 2704 across the biofouling map 2702B for CFPS. The circulation paths actuated by the pulse sequences (1,0,0,−1) 2720A and (1,0,−1,1,0,−1,1,0,−1,0) 2720E corresponding to 50% and 60% duty cycle of actuation can show notably less fouling than the pulse sequence (1,−1) 2010 which can be the control and can be used in all actuation applications. Reduced biofouling can be also noted for the actuation by the pulse sequence (1,0,0,0,−1) 2720A which can be consistent with historic experiments using the same pulse sequence. When the experiment is repeated with CFPS premix used as the reagent, there can be considerable pinning of the droplets over the repeated movement over several hours. The suitability of pulse sequences for movement can be noticed to be dependent on the amount of actuation. The pulse sequence (1,0,0,0,−1) 2720A can be used as an incubation sequence due to its low biofouling characteristics, but it not very suitable for moving droplets, which suggests that low actuation pulse sequences can be more suitable for incubation and small-scale movement like moving in a mixing pattern, whereas sequences with more actuation pulses can be more suitable for reliable movement. From this experiment, the pulse sequences (1,−1,0,−1) 2720G and (1,−1,0,1,−1) 2720I, corresponding to 75% and 80% duty cycles, can have reliable movement at the end of 21 hours of incubation while also causing notably lesser fouling than the pulse sequence (1,−1) 2010 which is currently the pulse sequence used as the standard for actuation. Incorporation of relaxation pulses into high duty cycle pulse sequences can thus reduce biofouling during large scale movement of droplets, e.g. in a circulatory pattern, with the pulse sequence (1,−1,0,−1) 2720G being an example to be considered. Droplets actuated by the pulse sequence (1,−1) 2010 can be pinned towards the end of the 21 h incubation period which can be late enough to consider the experiment completed.

As illustrated in FIGS. 27A-27H, there can be pinning for most of the droplets actuated, but the pulse sequences (1,−1,0,−1) 2720G and (1,−1,0,1,−1) 2720I can show continued movement after 21 hours of experiment. Pulse sequences that have the droplets coalesce and crash out of the actuation pattern can be mainly sequences that have a duty cycle of 60% or lower, and cannot be suitable for large scale movement of droplets, like in a circulation pattern although they can potentially be applied for small-scale movement like incubation and mixing. These results, as well as results with the pulse sequence (1,0,0,0,−1) 2720A suggest that actuation and biofouling can have an inverse relationship, and that there can be a compromise between them to determine optimal conditions for actuation.

### Computing Device

FIG. 28 is a block diagram of an exemplary computing device that can be used to perform one or more steps of the methods provided by exemplary embodiments. For example, computing device 2800 may be, but is not limited to the processing unit as described in FIG. 3A. The computing device 2800 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 2806 included in the computing device 2800 can store computer-readable and computer-executable instructions or software for implementing exemplary embodiments. The computing device 2800 also includes processor 2802 (e.g., the processing unit as illustrated in FIG. 3A) and associated core 2804, and optionally, one or more additional processor(s) 2802′ and associated core(s) 2804′ (for example, in the case of computer systems having multiple processors/cores), for executing computer-readable and computer-executable instructions or software stored in the memory 2806 and other programs for controlling system hardware. Processor 2802 and processor(s) 2802′ can each be a single core processor or multiple core (2804 and 2804′) processor. The computing device 2800 also includes a graphics processing unit (GPU) 2805. In some embodiments, the computing device 2800 includes multiple GPUs.

Virtualization can be employed in the computing device 2800 so that infrastructure and resources in the computing device can be shared dynamically. A virtual machine 2814 can be provided to handle a process running on multiple processors so that the process appears to be using only one computing resource rather than multiple computing resources. Multiple virtual machines can also be used with one processor.

Memory 2806 can include a computer system memory or random access memory, such as DRAM, SRAM, EDO RAM, and the like. Memory 2806 can include other types of memory as well, or combinations thereof. A user can interact with the computing device 2800 through a visual display device 2818, such as a touch screen display or computer monitor, which can display one or more user interfaces 2819. The visual display device 2818 can also display other aspects, elements and/or information or data associated with exemplary embodiments. The computing device 2800 can include other I/O devices for receiving input from a user, for example, a keyboard or any suitable multi-point touch interface 2808, a pointing device 2810 (e.g., a pen, stylus, mouse, or trackpad). The keyboard 2808 and the pointing device 2810 can be coupled to the visual display device 2818. The computing device 2800 can include other suitable conventional I/O peripherals.

The computing device 2800 can also include one or more storage devices 2824, such as a hard-drive, CD-ROM, or other computer readable media, for storing data and computer-readable instructions and/or software, such as one or more components of the system shown in FIG. 3A that implements exemplary embodiments of the notification system as described herein, or portions thereof, which can be executed to generate user interface 2819 on display 2818. Exemplary storage device 2824 can also store one or more databases for storing any suitable information required to implement exemplary embodiments. The databases can be updated by a user or automatically at any suitable time to add, delete or update one or more items in the databases. Exemplary storage device 2824 can store one or more databases 2826 for storing provisioned data, and other data/information used to implement exemplary embodiments of the systems and methods described herein.

The computing device 2800 can include a network interface 2812 configured to interface via one or more network devices 2822 with one or more networks, for example, Local Arca Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 2812 can include a built-in network adapter, network interface card, PCMCIA network card, card bus network adapter, wireless network adapter, USB network adapter, modem or any other device suitable for interfacing the computing device 2800 to any type of network capable of communication and performing the operations described herein. Moreover, the computing device 2800 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 2800 can run any operating system 2816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 2816 can be run in native mode or emulated mode. In an exemplary embodiment, the operating system 2816 can be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other embodiments, functions and advantages are also within the scope of the present disclosure

1. An electrowetting system for actuating aqueous droplets using a sequence of electrical pulses, the system including a plurality of electrodes configured to manipulate aqueous droplets in a microfluidic space, wherein each electrode is coupled to circuitry configured to selectively apply a pulse sequence of driving voltages to the electrodes; wherein the pulse sequence of driving voltages is used to move the droplets, or prevent fouling of the droplets, or hold the droplets, or some combination thereof.

2. The electrowetting system according to claim 1 for actuating droplets of a first composition and droplets of a second composition, the system including:
a plurality of electrodes configured to manipulate droplets of fluid in a microfluidic space, wherein each electrode is coupled to circuitry configured to selectively apply driving voltages to the electrode; and
a processing unit operably connected to a look up table (LUT) correlating drive sequences to chemical species and at least one composition parameter, the processing unit being configured to:
receive input data of a first chemical species and a first composition parameter of the first composition;
receive input data of a second chemical species and a second composition parameter of the second composition;
correlate a first drive sequence with the first chemical species and the first composition parameter, wherein the first drive sequence;
correlate a second drive sequence with the second chemical species and the second composition parameter; and
output the first drive sequence and the second drive sequence to the plurality of electrodes.

3. The electrowetting system according to claim 1 for actuating a mixed droplet, the system including:
a plurality of electrodes configured to manipulate droplets of fluid in a microfluidic space, wherein each electrode is coupled to circuitry configured to selectively applying driving voltages to the electrode; and
a processing unit operably connected to a look up table (LUT) correlating drive sequences to chemical species and at least one composition parameter, wherein the processing unit is configured to:
provide a first droplet with a first composition, a first volume, and a first composition parameter, wherein at least one of the first composition, first volume, and first composition parameter is correlated with a first drive sequence for the electrowetting system;
provide a second droplet with a second composition, a second volume, and a second composition parameter, wherein at least one of the second composition, second volume, and second composition parameter is correlated with a second drive sequence for the electrowetting system;
mix the first droplet and the second droplet to create a mixed droplet; and
drive the mixed droplet with a third drive sequence that is a predetermined weighted average of the first drive sequence and the second drive sequence.

4. An electrowetting system according to claim 1 for performing droplet operations, the system including:
a plurality of electrodes configured to manipulate droplets of fluid in a microfluidic space, wherein each electrode is coupled to circuitry configured to selectively apply driving voltages to the electrode; and
a processing unit operably connected to a look up table (LUT) correlating drive sequences to chemical species, the processing unit being configured to:
receive input data of a droplet operation to be performed on at least one droplet of at least one composition;
receive input data of a chemical species of the at least one composition;
correlate at least one drive sequence to the droplet operation;
form a driving protocol including the at least one drive sequence; and
output the at least one drive sequence to the plurality of electrodes, to execute the driving protocol and perform the droplet operation.

5. The electrowetting system according to any one preceding claim, wherein the processing unit is further configured to:
correlate the first chemical species and the first composition parameter to at least one reagent-specific drive scheme in the LUT;
receive input data of a droplet operation for the first composition;
correlate the input data of the droplet operation to at least one reagent-specific drive scheme applicable to the droplet operation, wherein the reagent-specific drive scheme is selected from the at least one reagent-specific drive profile; and
select the first drive sequence from the at least one reagent-specific drive scheme,
before outputting the first drive sequence to the plurality of electrodes.

6. The electrowetting system according to any one preceding claim, wherein the droplet operation for the first composition is selected from the group consisting of: loading a droplet into the microfluidic space; dispensing one or more droplets from a reservoir; splitting a droplet into two or more droplets; moving a droplet from one location to another; merging or combining two or more droplets into a single droplet; diluting a droplet; mixing a droplet; deforming a droplet; holding a droplet in position; heating a droplet; cooling a droplet; transporting a droplet out of the microfluidic space; and combinations thereof.

7. The electrowetting system according to any one preceding claim, wherein the look up table (LUT) is in the form of a file system or located in virtual memory associated with one or more computer systems.

8. The electrowetting system according to any one preceding claim, wherein the plurality of electrodes are pixel electrodes in an active matrix electrowetting on dielectric (AM-EWoD) device, wherein the pixel electrodes are switched by a transistor matrix and each transistor of the matrix is operably connected to a gate line, a source line, and a pixel electrode.

9. The electrowetting system according to claim 2, wherein the first composition parameter and the second composition parameter are independently selected from the group consisting of a chemical species concentration, a rheological property, pH, temperature, ionic strength, conductivity, light absorbance, and combinations thereof.

10. The electrowetting system according to claim 9, wherein the first composition parameter is the concentration of the first chemical species in the first composition and the second composition parameter is the concentration of the second chemical species in the second composition.

11. The electrowetting system according to any one preceding claim, wherein the pulse sequence for moving the droplets comprises at least three consecutive positive pulses or the pulse sequence is positively biased to move the droplets.

12. The electrowetting system according to any one preceding claim, wherein the at least three consecutive positive pulses comprises at least one of
1, 1, 1, 0;
1, 1, 1, 0, 1, −1, 0;
1, 1, 1, 1, 0;
1, 1, 1, 1, 0, 1, −1, 0; or
1, 1, 1, 1, −1, −1, −1, −1

13. The electrowetting system according to any one preceding claim, wherein the pulse sequence for preventing fouling comprises at least one of:
1,0,−1;
1,0,0,−1;
1,0,0,0,−1;
1,0,−1,−1;
1,−1,0,−1;
1,1,0,0,0,−1,−1; or
1,−1,0,1,−1.

14. The electrowetting system according to claim 13, wherein the pulse sequence having 1,0,−1,−1 further moves the droplets.

15. The electrowetting system according to claim 13, wherein the pulse sequence having 1,0,0,0,−1 further holds the droplets for extended periods.

16. The electrowetting system according to any one preceding claim wherein the pulse voltage is +15 V for each positive pulse.

17. The electrowetting system according to claim 2, wherein the first drive sequence comprises at least three consecutive positive pulses or the first drive sequence is positively biased.

18. The electrowetting system according to claim 2 or claim 15, wherein the second drive sequence is a balanced sequence alternating 1, −1.

19. The electrowetting system according to claim 2, wherein the first drive sequence comprises at least one of:
1, 1, 1, 0;
1, 1, 1, 0, 1, −1, 0;
1, 1, 1, 1, 0;
1, 1, 1, 1, 0, 1, −1, 0;
1, 1, 1, 1, −1, −1, −1, −1
1,0,−1;
1,0,0,−1;
1,0,0,0,−1;
1,0,−1,−1;
1,−1,0,−1;
1,1,0,0,0,−1,−1; or
1,−1,0,1,−1.
and the second drive sequence is a balanced sequence alternating 1, −1.

20. A method for performing droplet operations on a first composition and a second composition in an electrowetting system, the electrowetting system comprising a plurality of electrodes configured to manipulate droplets of fluid in a microfluidic space, wherein each electrode is coupled to circuitry configured to selectively apply driving voltages to the electrode; and
driving the first composition with a pulse sequence of driving voltages, the pulse sequence comprises at least one of:
at least three consecutive positive pulses;
a positively biased sequence;
1,0,−1;
1,0,0,−1;
1,0,0,0,−1;
1,0,−1,−1;
1,−1,0,−1;
1,1,0,0,0,−1,−1; or
1,−1,0,1,−1; and
driving the second composition with a charge-neutral drive sequence alternating 1, −1.

21. A method for performing droplet operations on a first composition and a second composition in an electrowetting system according to claim 20, the electrowetting system comprising:
a plurality of electrodes configured to manipulate droplets of fluid in a microfluidic space, wherein each electrode is coupled to circuitry configured to selectively apply driving voltages to the electrode; and
a processing unit operably connected to a look up table (LUT) correlating drive sequences to chemical species and composition parameters,
the method comprising:
receiving input data of a first chemical species and a first composition parameter of the first composition;
receiving input data of a second chemical species and a second composition parameter of the second composition;
correlating a first drive sequence with the first chemical species and first composition parameter of the first composition, wherein the first drive sequence comprises the pulse sequence;
correlating a second drive sequence with the second chemical species and second composition parameter of the second composition; and
outputting the first drive sequence and the second drive sequence to the plurality of electrodes.

22. The method according to claim 20, wherein the droplet operation is selected from the group consisting of: loading a droplet into the microfluidic space; dispensing one or more droplets from a reservoir; splitting a droplet into two or more droplets; moving a droplet from one location to another; merging or combining two or more droplets into a single droplet; diluting a droplet; mixing a droplet; deforming a droplet; holding a droplet in position; heating a droplet; cooling a droplet; transporting a droplet out of the microfluidic space; and combinations thereof.

23. The method according to claim 20, wherein the method comprises a pulse width modulated drive sequence.

24. The method according to claim 20, wherein driving the first composition with the pulse sequence is based on a e motion scheme comprising a correcting pulse.

25. The method according to claim 20, wherein driving the first composition with the pulse sequence is based on a reagent-specific drive scheme comprising a dispensing scheme for dispensing droplets from a reservoir.

26. The method according to claim 20, wherein driving the first composition with the pulse sequence is based on a reagent-specific drive scheme comprising a scheme for merging two or more reactant droplets.

27. The method according to claim 20, wherein the at least three consecutive positive pulses or the positively biased sequence moves the first composition.

28. The method according to claim 20, wherein at least one of
1,0,−1;
1,0,0,−1;
1,0,0,0,−1;
1,0,−1,−1;
1,−1,0,−1;
1,1,0,0,0,−1,−1; or
1,−1,0,1,−1
prevents fouling.

29. The method according to claim 28, wherein the pulse sequence having 1.0,−1,−1 further moves the droplets.

30. The method according to claim 28, wherein the pulse sequence having 1.0.0.0,−1 further holds the droplets for extended periods.
